(19) United States
(12) Patent Application Publication
(10) Pub. No.: US 2025/0004197 A1
(43) Pub. Date: Jan. 2, 2025

(54) DIRECTLY BONDED OPTICAL COMPONENTS

(71) Applicant: Adeia Semiconductor Bonding Technologies Inc., San Jose, CA (US)

(72) Inventors: Belgacem Haba, Saratoga, CA (US); Rajesh Katkar, Milpitas, CA (US); Mani Hossein-Zadeh, Huntington Beach, CA (US)

(21) Appl. No.: 18/745,266

(22) Filed: Jun. 17, 2024

Related U.S. Application Data
(60) Provisional application No. 63/511,388, filed on Jun. 30, 2023.

(51) Int. Cl. G02B 6/12

(52) U.S. Cl. CPC G02B 6/12004

(57) ABSTRACT

A directly bonded optical component comprising one or more optical channels is disclosed. The directly bonded optical component can include at least a first optical element and a second optical element directly bonded to the first optical element without an intervening adhesive. The optical component can include a first optical channel through at least a portion of the first optical element, the first optical channel extending between a first port at a first side of the optical component and a second port at a second side of the optical component. A second optical channel or waveguide can extend through at least a portion of the second optical element from a third port at the first side of the optical component to a fourth port. The first and third ports can be separated by a first distance and the second and fourth parts can be separated a second distance along an exterior surface of the optical component. The first distance can be different from the second distance.

### CROSS-REFERENCE TO RELATED APPLICATIONS

This application claims priority to U.S. Provisional Application No. 63/511,388, filed Jun. 30, 2023, titled “DIRECTLY BONDED OPTICAL COMPONENTS,” the disclosure of which is incorporated herein by reference in its entirety for all purposes.

### BACKGROUND

### Field

The field relates to directly bonded optical components and optical communication devices.

### Description of the Related Art

Optical interconnects may be provided between semiconductor device dies or chips, such as graphics processing units (GPUs), Application Specific Integrated Circuits (ASIC), memory chips, etc. which can be provided within products like transceivers, switches, etc. for networking, datacenter, and other applications. The optical interconnects facilitate optical communication between the semiconductor device dies or electrical and optical components in general. Additionally, optical channels (such as optical waveguides) may be layered within a medium, or three-dimensional (3D) optical waveguides may be formed within a medium, like glass along with traditional packaging substrates (e.g., printed circuit board (PCB)). Optical signals or electromagnetic radiation can be transferred through the optical channels. However, it can be challenging to efficiently manufacture optical components that provide communication between semiconductor dies. Accordingly, there remains a continuing need for improved optical components.

### SUMMARY

In one aspect, an optical component includes: a first optical element; a second optical element disposed over the first optical element; a first optical channel through at least a portion of the first optical element, the first optical channel extending between a first port at a first side of the optical component and a second port at a second side of the optical component; and a second optical channel through at least a portion of the second optical element, the second optical channel extending between a third port at the first side of the optical component and a fourth port, wherein the first and third ports are spaced apart by a first distance along the first side, and wherein the second and fourth ports are spaced apart by a second distance along an exterior surface of the optical component, the first distance different from the second distance.

In some embodiments, the second optical element is directly bonded to the first optical element without an intervening adhesive. In some embodiments, the fourth port is disposed at the second side of the optical component. In some embodiments, the second side is parallel to or at an angle to the first side of the optical component. In some embodiments, the fourth port is disposed at a third side of the optical component different from the second side. In some embodiments, the first optical channel is a waveguide. In some embodiments, the first distance is less than the second distance. In some embodiments, the optical component can include: a third optical channel through at least a portion of the first optical element, the third optical channel extending between a fifth port at the first side of the optical component and a sixth port at the second side of the optical component; and a fourth optical channel through at least a portion of the second optical element, the fourth optical channel extending between a seventh port at the first side of the optical component and an eighth port at the second side of the optical component, wherein the fifth and seventh ports are spaced apart by a third distance, and wherein the sixth and eighth ports are spaced apart by a fourth distance, the third distance different from the fourth distance. In some embodiments, the optical component can include a first optical device directly bonded to the first and second optical channels and a second optical device directly bonded to the third and fourth optical channels. In some embodiments, the first optical device is an emitter, and the second optical device is a receiver. In some embodiments, the emitter is a vertical-cavity surface-emitting laser, a photonic crystal surface-emitting laser, an edge-emitting laser, or a low-power LED. In some embodiments, the receiver is a photodiode or a complementary metal-oxide semiconductor sensor. In some embodiments, the first optical device and the second optical device are directly bonded to a first die. In some embodiments, the first die controls the operation of at least one of the first or the second optical devices. In some embodiments, the first optical device and the second optical device are thermocompression bonded to a first die. In some embodiments, the optical component can include an adapter assembly configured to couple an optical fiber to at least the second port. In some embodiments, the optical component can include at least a first optical grating disposed in the first optical channel. In some embodiments, the first optical channel extending from the first port can include at least one optical power divider and the at least one optical power divider can include a Y-junction and a first and a second branching optical channel. In some embodiments, the first optical channel includes a first waveguide portion, and the second optical channel includes a second waveguide portion, and the first and second waveguide portions are optically coupled to form a directional coupler. In some embodiments, the first optical device is directly bonded to a first die, and the second optical device is directly bonded to a second die. In some embodiments, the optical component can include a first optical device and a second optical device, wherein the first optical device comprises a fifth optical channel and a first grating coupler that couples the fifth optical channel to the first optical channel in the optical component, and wherein the second optical device comprises a sixth optical channel and a second grating coupler that couples the sixth optical channel to the third optical channel in the optical component. In some embodiments, the optical component can include an adapter assembly coupled to at least the second, fourth, sixth, and eighth ports on a first side of the adapter assembly. In some embodiments, the adapter assembly is a multi-fiber connector configured to couple to a plurality of fiber cores. In some embodiments, the optical component can include a bridging optical channel extending from an input port at the first side of the optical component to an output port at the first side of the optical component, wherein the input port is bonded to the first optical device and the output port is bonded to the second optical device. In some embodiments, the optical component bridges the first die and the second die. In some embodiments, the input port and the output port are disposed at a same side of the optical component.

In another aspect, an optical component includes: a first optical element having a first port and a third port along a first side of the optical component, the first and third ports spaced apart by a first distance along the first side, the first optical element including at least a first portion of a first optical channel extending from the first port and at least a first portion of a second optical channel extending from the third port; and a second optical element disposed over the first optical element, the second optical element including at least a second portion of the first optical channel; wherein the first optical channel extends from the first port to a second port disposed along a second side of the optical component, wherein the second optical channel extends from the third port to a fourth port disposed along the second side of the optical component, the second and fourth ports spaced apart by a second distance along the second side, the second distance different from the first distance.

In some embodiments, the second optical element is directly bonded to the first optical element without an intervening adhesive. In some embodiments, the first optical channel is a waveguide. In some embodiments, the first distance is less than the second distance. In some embodiments, the optical component can include a fifth port and a seventh port along the first side of the optical component, the fifth and seventh ports spaced apart by a third distance along the first side, the first optical element including at least a first portion of a third optical channel extending from the fifth port and at least a first portion of a fourth optical channel extending from the seventh port, and the second optical element including at least a second portion of the third optical channel, wherein the third optical channel extends from the fifth port to a sixth port disposed along the second side of the optical component, wherein the fourth optical channel extends from the seventh port to an eighth port disposed along the second side of the optical component, the sixth and eighth ports spaced apart by a fourth distance along the second side, the fourth distance different from the third distance. In some embodiments, the optical component can include a first optical device directly bonded to the first and second optical channels and a second optical device directly bonded to the third and fourth optical channels. In some embodiments, the first optical device is a receiver, and the second optical device is an emitter. In some embodiments, the emitter is a vertical-cavity surface-emitting laser, a photonic crystal surface-emitting laser, an edge-emitting laser, or a low-power LED. In some embodiments, the receiver is a photodiode or a complementary metal-oxide semiconductor sensor. In some embodiments, the first optical device and the second optical device are directly bonded to a first die. In some embodiments, the first optical device and the second optical device are thermocompression bonded to a first die. In some embodiments, the optical component can include an adapter assembly coupled to at least the second, fourth, sixth, and eighth ports on a first side of the adapter assembly. In some embodiments, the optical component can include at least a first optical grating disposed in the first optical channel. In some embodiments, the first optical channel comprises at least one optical power divider, and the at least one optical power divider can include a Y-junction and a first and a second branching optical channel. In some embodiments, the first optical channel comprises a first portion of the first optical channel and the second optical channel comprises a first portion of the second optical channel, wherein the first portion of the first optical channel and the first portion of the second optical channel are optically coupled to form a directional coupler. In some embodiments, the first optical device is directly bonded to a first die, and the second optical device is directly bonded to a second die. In some embodiments, the optical component can include a first optical device and a second optical device, wherein the second optical device comprises a fifth optical channel and a first grating coupler that couples the fifth optical channel to the first optical channel in the optical component, and wherein the second optical device comprises a sixth optical channel and a second grating coupler that couples the sixth optical channel to the third optical channel in the optical component. In some embodiments, the optical component can include an adapter assembly coupled to at least the second, fourth, sixth, and eighth ports on a first side of the adapter assembly. In some embodiments, the adapter assembly is a multi-fiber connector configured to couple to a plurality of fiber cores.

In another aspect, an optical component includes: a first bonded structure having a first side and a second side; a first port and a third port disposed at the first side of the first bonded structure, the first and third ports spaced apart by a first distance; a second port and a fourth port disposed at the second side of the first bonded structure, the second and fourth ports spaced apart by a second distance different from the first distance; a first optical channel extending at least partially through the first bonded structure between the first and second ports; and a second optical channel extending at least partially through the first bonded structure between the third and fourth ports.

In some embodiments, the first optical channel is a waveguide. In some embodiments, the optical component can include: a fifth port and a seventh port disposed at the first side of the first bonded structure, the fifth and seventh ports spaced apart by a third distance; a sixth port and an eighth port disposed at the second side of the first bonded structure, the sixth and eighth ports spaced apart by a fourth distance different from the third distance; a third optical channel extending at least partially through the first bonded structure between the fifth and sixth ports; and a fourth optical channel extending at least partially through the first bonded structure between the seventh and eighth ports. In some embodiments, the optical component can include a plurality of optical devices directly bonded to the first side of the bonded structure. In some embodiments, the plurality of optical devices comprises a first emitter and a first receiver. In some embodiments, the first emitter is coupled to at least the first optical channel and the first receiver is coupled to at least the third optical channel. In some embodiments, the first emitter and the first receiver are directly bonded to a first die. In some embodiments, the first emitter is directly bonded to a first die and the first receiver is directly bonded to a second die. In some embodiments, the optical component can include a second bonded structure, a fifth optical channel extending at least partially through the second bonded structure, and a coupling element extending from the fifth optical channel and coupled to the first optical channel of the first bonded structure. In some embodiments, the coupling element is a grating coupler. In some embodiments, the optical component can include an adapter assembly coupled to at least the second and fourth ports on a first side of the adapter assembly. In some embodiments, the adapter assembly is a multi-fiber connector configured to couple to a plurality of fiber cores.

In another aspect, an optical component includes: a bonded structure having a first side and a second side; a first optical channel extending at least partially through the bonded structure between the first and second sides; and a second optical channel extending at least partially through the bonded structure between the first and second sides, the second optical channel including a first channel portion extending from the first side along a first direction and a second channel portion extending along a second direction different from the first direction.

In some embodiments, the first optical channel is a waveguide. In some embodiments, the optical component can include an optical device directly bonded to the first side of the bonded structure. In some embodiments, the optical device is coupled to at least the first optical channel of the bonded structure. In some embodiments, the optical device is directly bonded to a first die. In some embodiments, the optical component can include a second bonded structure having a third optical channel including a grating coupler, wherein the grating coupler couples to the first optical channel. In some embodiments, the optical component can include an adapter assembly coupled to the second side of the bonded structure, wherein the adapter assembly transmits electromagnetic radiation to or from at least the first optical channel from or to an external fiber core. In some embodiments, the adapter assembly is a multi-fiber connector configured to couple to a plurality of fiber cores.

In another aspect, a method of forming an optical component can include: providing a first optical channel through at least a portion of a first optical element and between a first port and a second port; providing a second optical channel through at least a portion of a second optical element and between a third port and a fourth port; and disposing the first optical element over the second optical element, wherein the first and third ports are spaced apart by a first distance along a first side of the optical component, and wherein the second and fourth ports are spaced apart by a second distance along a second side of the optical component, the first distance different from the second distance.

In some embodiments, the method can include directly bonding the first optical element to the second optical element without an intervening adhesive. In some embodiments, the method can include: providing a third optical channel through at least a portion of the first optical element between a fifth port and a sixth port; and providing a fourth optical channel through at least a portion of the second optical element between a seventh port and an eighth port, wherein the fifth and seventh ports are spaced apart by a third distance along the first side of the optical component, and wherein the sixth and eighth ports are spaced apart by a fourth distance along the second side of the optical component, the fourth distance different from the third distance. In some embodiments, the method can include directly bonding a first optical device to the first and second optical channels and directly bonding a second optical device to the third and fourth optical channels. In some embodiments, the method can include directly bonding the first optical device and the second optical device to a first die. In some embodiments, the method can include coupling an adapter assembly to at least the second, fourth, sixth, and eighth ports on a first side of the adapter assembly. In some embodiments, the method can include embedding at least a first grating in the first optical channel. In some embodiments, the method can include forming at least a first Y-junction in the first optical channel. In some embodiments, the method can include coupling a first portion of the first optical channel and a first portion of the second optical channel to form a directional coupler in the optical component. In some embodiments, the method can include directly bonding the first optical device to a first die, and directly bonding the second optical device to a second die. In some embodiments, the method can include coupling a first grating coupler extending from a fifth optical channel in a second optical component to the first optical channel in the first optical component and coupling a second grating coupler extending from a sixth optical channel in a third optical component to the third optical channel in the first optical component.

In another aspect, an optical component comprises: a first optical element comprising a bottom side and a top side; at least one optical channel through at least a portion of the first optical element; a second optical element directly bonded to the top side of the first optical clement without an intervening adhesive, the second optical element at least partially defining the at least one optical channel; a first input port at the bottom side of the first optical clement; and a first output port at the bottom side of the first optical element, wherein the at least one optical channel extends between the first input port and the first output port.

In some embodiments, the at least one optical channel is an optical waveguide. In some embodiments, the optical component bridges a first die and a second die. In some embodiments, the optical component can include a first optical device coupled to the first input port and a second optical device coupled to the first output port. In some embodiments, the first optical device is an emitter or a receiver. In some embodiments, the first optical device comprises an optical waveguide and a grating coupler, wherein electromagnetic radiation is propagated through the optical waveguide and the grating coupler, and wherein the grating coupler couples the electromagnetic radiation to the first input port.

In another aspect, an optical component can include: a first optical element; a second optical element directly bonded to the first optical element without an intervening adhesive; a first optical channel through at least a portion of the first optical element, the first optical channel extending between a first port at a first side of the optical component and a second port at a second side of the optical component, and a second optical channel through at least a portion of the second optical element, the second optical channel extending between a third port at the first side of the optical component and a fourth port at a third side of the optical component.

In some embodiments, the first optical channel is an optical waveguide. In some embodiments, the optical component can include at least a first optical grating disposed in the first optical channel. In some embodiments, the first optical channel comprises at least one optical power divider, the at least one optical power divider further comprising a Y-junction and a first and a second branching optical channel. In some embodiments, the first optical channel comprises a first portion of the first optical channel and the second optical channel comprises a first portion of the second optical channel, and the first portion of the first optical channel and the first portion of the second optical channel are optically coupled to form a directional coupler. In some embodiments, the optical component can include a first optical device coupled to the first and third ports and a second optical device coupled to at least the second port or the fourth port. In some embodiments, the first optical device is an emitter or a receiver. In some embodiments, the first optical device comprises an optical waveguide and a grating coupler, wherein electromagnetic radiation is propagated through the optical waveguide and the grating coupler, and the grating coupler couples the electromagnetic radiation to the first port.

### BRIEF DESCRIPTION OF THE DRAWINGS

FIG. 1A is a schematic side sectional view of an optical element including a first layer, a second layer, a first optical channel, a first port on a first side of the optical element, and a second port on a second side of the optical element.

FIG. 1B is a schematic top sectional view of an optical element including a plurality of optical channels and a plurality of ports.

FIG. 1C illustrates a depth view of a fabrication process for forming an optical element.

FIG. 2A is a schematic side sectional view of an optical component, according to one embodiment.

FIG. 2B is a schematic side sectional view of an optical component, according to another embodiment.

FIG. 3A is a schematic side sectional view of an optical component including a first optical element having a first optical channel, according to one embodiment.

FIG. 3B is a schematic top sectional view of an optical element including a plurality of optical channels, according to one embodiment.

FIG. 3C is a schematic depth sectional view of a fabrication process, illustrating etching into a single material and forming a plurality of optical channels, according to one embodiment.

FIG. 3D is a schematic side sectional view, illustrating etching into a single material and forming a first optical channel, according to one embodiment.

FIG. 4A is a schematic side sectional view of an optical component prior to bonding of the layers, according to one embodiment.

FIG. 4B is a schematic side sectional view of an optical component, according to one embodiment.

FIG. 5A is a schematic side sectional view of an optical component prior to bonding of the layers, according to an alternative embodiment.

FIG. 5B is a schematic side sectional view of an optical component, according to one embodiment.

FIG. 6 is a schematic side sectional view of an optical component including a first optical device and a second optical device, according to one embodiment.

FIG. 7 is a schematic side sectional view of an optical component including a first die, according to one embodiment.

FIG. 8 is a schematic side sectional view of an optical component including an adapter assembly, according to one embodiment.

FIG. 9 is a schematic side sectional view of an optical component including a plurality of first optical devices, according to one embodiment.

FIG. 10A is a schematic side sectional view of an optical component including first and second gratings, according to one embodiment.

FIG. 10B is a schematic top sectional view of an optical component including first and second gratings, according to one embodiment.

FIG. 11A is a schematic side sectional view of an optical element including a first optical channel, according to one embodiment.

FIG. 11B is a schematic side sectional view of an optical element including a first optical channel, a phase mask, ultraviolet (UV) radiation, and a first grating, according to one embodiment.

FIG. 11C is a schematic side sectional view of an optical component including a first grating, according to one embodiment.

FIG. 12A is a schematic side sectional view of an optical component, according to one embodiment.

FIG. 12B is a schematic top sectional view of an optical component including a Y-junction, according to one embodiment.

FIG. 13A is a schematic side sectional view of an optical component, according to one embodiment.

FIG. 13B is a schematic top sectional view of an optical component including a first optical channel having a first coupling portion and a second optical channel having a second coupling portion, according to one embodiment.

FIG. 14 is a schematic side sectional view of an optical component optically interconnecting two optical devices, according to one embodiment.

FIG. 15A is a schematic side sectional view of an optical component optically interconnecting two optical devices, according to one embodiment.

FIG. 15B is a schematic top sectional view of a first optical device, according to one embodiment.

FIG. 16A is a schematic side sectional view of an optical component including a plurality of optical channels and a first optical device, according to one embodiment.

FIG. 16B is a schematic top sectional view of a first optical device including a plurality of optical channels comprising a plurality of grating couplers, according to one embodiment.

FIG. 17A is a schematic side sectional view of an optical assembly comprising an optical component optically connecting a first optical device to a second optical device, according to one embodiment.

FIG. 17B is a schematic top sectional view of a first optical device including a plurality of optical channels comprising a plurality of grating couplers, according to one embodiment.

FIG. 18A is a schematic side sectional view of a first microelectronic element and a second microelectronic element, according to one embodiment.

FIG. 18B is a schematic side sectional view of a first microelectronic element and a second microelectronic element directly hybrid bonded to one another, according to one embodiment.

Like reference numbers are used to refer to like features throughout the description and drawings.

### DETAILED DESCRIPTION

Designing and implementing systems using optical communications, such as optical interconnects between semiconductor devices or layers of optical waveguides within a device, is beneficial for architectural and bandwidth reasons. With technological advances and innovations, there is an increased demand for greater bandwidth and additional features in microelectronic devices. However, increasing the density of electrical interconnects and/or additional features within these microelectronic devices is insufficient to adequately meet these demands because of the corresponding increases in power consumption and noise. Thus, photonics devices have arisen as a solution to meeting these demands. Example applications of such photonics devices are to enable efficient co-packaged optics for networking and computing in datacenters and other high-demand, high-bandwidth applications. Processor chips transfer electrical signals within the chip and to other chips and external devices (e.g., other electronic components or chips, system boards, etc.). The electrical signals used for processing, may be converted to optical signals for faster transmission, and then converted back to electrical signals for further processing. Photonics devices use optical signals which reduce crosstalk issues and result in less noisy signals with increases in bandwidth. Furthermore, as technology develops and the limits of Moore's law are being reached, alternative technologies are being developed to address the need for increased computing power, memory capacity, and bandwidth for memory transfer. Chips and other components, including light sources like lasers, LEDs, and electrical or optical waveguides (e.g., organic and optical substrates), that maintain electrical signaling and/or the conversion process between electrical and optical signals are facing increasing difficulties with inter-chip communications and packaging, and thus limit the progress of other technologies, such as artificial intelligence (AI) technologies (e.g., machine learning).

To address the shortcomings of electronic devices, developments have been made in the area of integrated photonics and generally, optical communication within chips (e.g., intra-chip communications) and between chips (e.g., inter-chip communications). Recent developments include using an optical interconnect between two GPU devices and layering optical waveguides within a material to increase bandwidth. Research and development are ongoing to improve how to optically connect these devices. Present solutions for optically connecting devices include connecting a chip with optical connections (e.g., waveguides) to an external element or another chip, where a connecting element comprising an optical source like lasers and optical fibers or photonic wire bonds is fixed to the chip. For example, V-shaped grooves may be formed within a chip and the exposed portions of external fibers attached to a mechanical transfer-type (MT-type) connector are fitted into the grooves and adhered using an ultraviolet adhesive (UV-adhesive).

Thus, there remains a continuing need for a standard optical socket connection on the chip level to provide intra- and inter-chip optical communications. One solution is to stack layers (e.g., dielectric layers) forming optical channels (e.g., optical waveguides) within an optical component (e.g., using techniques like deposition, direct bonding techniques, etc.) that help facilitate the fanning out of the pitch between the input ports of the optical channels and the output ports of the optical channels. Fanning out the pitch (e.g., going from very fine pitch to coarse pitch) between the ports of the optical channels can allow for the use of different pitch emitters and receivers at the input ports of the optical channels, while implementing a standard optical socket at the location of the exit ports of the optical channels. In this way, the pitch of contact pads on the dies may be significantly smaller than the pitch of the contact pads or terminals of the larger external device to which the dies are to be connected. The optical component facilitates efficient transmission of information in the form of electromagnetic radiation and can be a modular component in larger scale systems.

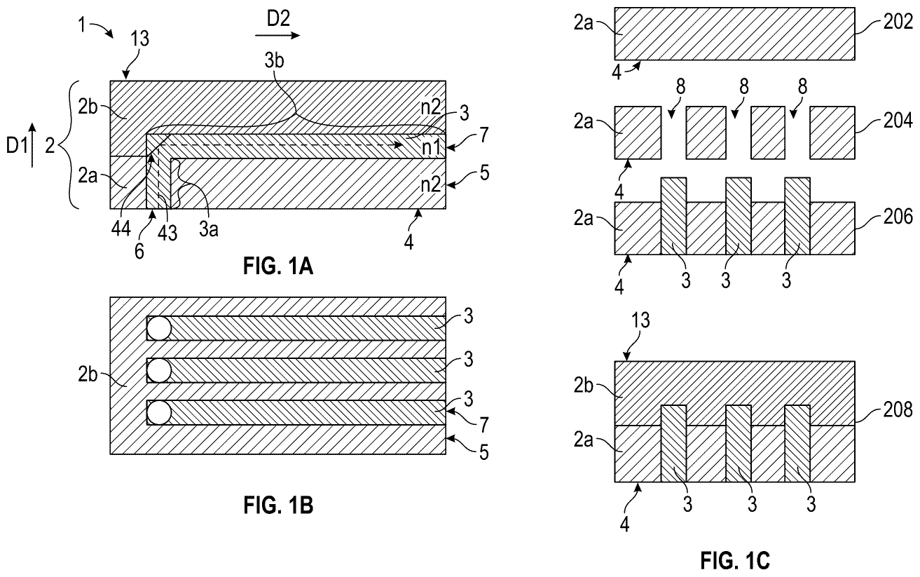

Various embodiments disclosed herein relate to optical components, including directly bonded components. FIG. 1A illustrates an optical component 1 comprising a first optical element 2. A first optical channel 3, such as an optical waveguide, is formed in the first optical element 2. A first portion 3a of the first optical channel 3 is formed in a first layer 2a of the first optical element 2 and a second portion 3b of the first optical channel 3 is formed in a second layer 2b of the first optical element 2. The second layer 2b of the first optical element 2 can be disposed over the first layer 2a of the first optical element 2. In one example, a trench 8 (see FIG. 1C) is created in the first layer 2a and the first portion 3a of the first optical channel 3 is deposited over the first layer 2a and into the trench 8. A mask can be used to facilitate etching back the first layer 2a to leave the first optical channel 3 protruding from the first layer 2a. The second layer 2b can then be deposited over the etched-back first layer 2a and the protruding first optical channel 3 corresponding to the second portion 3b.

In some embodiments, the layers 2a, 2b, and the first optical channel 3 are formed using materials including semiconductor materials (e.g., silicon), inorganic dielectrics (e.g., silicon oxide, silicon nitride, silicon oxycarbonitride, silicon oxynitride, etc.), glass, and/or organic dielectrics (e.g., polymers). In other embodiments, one or more of layers 2a, 2b, and the first optical channel 3 are formed using optical materials, including organic or inorganic materials (e.g., ceramics and glasses like quartz, borosilicate, fused silica, etc., and specialized glass compositions as well as polymer materials like silicone, polycarbonate, acrylic, etc.). In other embodiments, materials supporting a portion of the light spectrum other than the visible spectrum (e.g., NIR, SWIR, etc.) may also be used. In some embodiments, the first optical channel 3 is formed using deposition processes like chemical vapor deposition (CVD), liquid phase epitaxy (LPE), vapor-phase epitaxy (VPE), or molecular beam epitaxy (MBE), printing, injection molding, etc. The optical channel 3 has an index of refraction n1 and the material or cladding that comprises the optical element outside of the optical channel has an index of refraction n2, where n1 is greater than n2. In this configuration, electromagnetic radiation 43 travels through the first optical channel 3 by entering the optical component 1 through a first port 6 at a first side 4 of the optical component 1, propagating through the first optical channel 3 in a first direction D1, and impinging upon an angled surface 44 such that the electromagnetic radiation 43 is reflected into a second direction D2 that is different from the first direction D1. The angled surface 44 is at an angle dependent on the direction the second direction D2 is to take with respect to the first direction D1. In one embodiment, direction D1 may be in the vertical direction (e.g., along the z-axis) and direction D2 may be pointing in any direction along the xy-plane that is orthogonal to the z-axis. The angled surface 44 can be positioned at an angle value within the range of 35-60 degrees. In one embodiment, the angled surface 44 is at an angle of approximately 45 degrees to the first direction D1. In some embodiments, the angled surface 44 is a polished surface. In some embodiments, the angled surface 44 is a mirror. In some embodiments, the materials or cladding surrounding the optical channel may consist of more than one material with different refractive indices (e.g., n2′ and n2″, both smaller than n1). For example, a portion of layer 2a surrounding the first portion 3a of optical channel may be formed of a material with a refractive index n2′ and a portion of layer 2b surrounding the second portion 3b of optical channel may be formed of a material with refractive index n2″.

The electromagnetic radiation 43 propagates through the first optical channel 3 in the second direction D2 and exits the optical component 1 through a second port 7 at a second side 5 with respect to the first side 4. The second side 5 in FIG. 1A is shown to be a side that is approximately perpendicular to the first side 4. It should be noted that in some embodiments, the second side may refer to an approximately parallel or opposing side with respect to the first side 4 of the optical component 1. This approximately opposing side can also be referred to as the top side 13. In one embodiment, the electromagnetic radiation comprises infrared radiation (IR) (e.g., IR values from approximately 1.1 μm to 7 μm). In other embodiments, other wavelengths of electromagnetic radiation may be suitable (e.g., 0.4 μm to 20 μm).

A plurality of optical channels 3 can be formed in the optical component 1. FIG. 1B shows the top view of the optical component 1, which includes a plurality of optical channels 3.

FIG. 1C illustrates a depth view of the fabrication process of optical component 1. A first layer 2a is shown in step 202. The first layer 2a can comprise any suitable material such as semiconductor materials (e.g., silicon) and inorganic dielectrics (e.g., silicon oxide, silicon nitride, silicon oxycarbonitride, silicon oxynitride, etc.). In other embodiments, one or more of layers 2a, 2b, and the first optical channel 3 are formed using optical materials, including organic or inorganic materials (e.g., ceramics and glasses like quartz, borosilicate, fused silica, etc. and specialized glass compositions as well as polymer materials like silicone, polycarbonate, acrylic, etc.). In other embodiments, materials supporting a portion of the light spectrum other than the visible spectrum (e.g., NIR, SWIR, etc.) may also be used. In step 204, one or more trenches 8 can be formed in the first layer 2a. Trenches 8 are formed at the places shown as portion 3a of the optical channel 3. For example, the trenches 8 can be formed by etching (e.g., wet etching or dry etching). In step 206, a second suitable material is deposited in the one or more trenches 8. Step 206 may be a 2-step process including a first step of deposition and a second step of etching the optical cavity material. In step 206, a suitable material is deposited in the trenches 8, covering layer 2a to a required thickness, and then patterned (i.e., removed by dry or wet etching, etc.) to form the optical channels. The second suitable material can comprise semiconductor materials (e.g., silicon) and inorganic dielectrics (e.g., silicon oxide, silicon nitride, silicon oxycarbonitride, silicon oxynitride, etc.). The second suitable material may also be any other organic or organic optical material as described before. The deposited material and the first layer 2a, as illustrated, can be patterned such that the deposited material is configured to protrude above the first layer 2a and the protruded portion is extended in the direction so as to form the portion 3B of the optical channel 3. In step 208, a second layer 2b is deposited over the first layer 2a including the protruding second suitable material, forming optical channel 3. Like the first layer 2a, the second layer 2b can comprise any suitable material such as semiconductor materials (e.g., silicon) and inorganic dielectrics (e.g., silicon oxide, silicon nitride, silicon oxycarbonitride, silicon oxynitride, etc.). FIG. 1D also depicts the cross section going through portion 3a of the optical channel 3 in the direction orthogonal to the cross section shown in FIG. 1A.

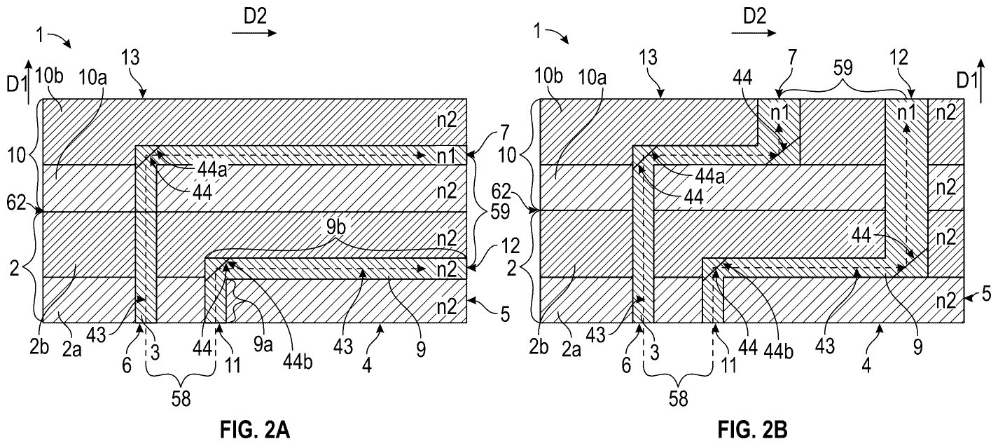

FIG. 2A illustrates an optical component 1, according to one embodiment. The optical component 1 comprises a first optical channel 3 extending from a first port 6 at a first side 4 (e.g., a bottom side) of the optical component 1, through at least a portion of a first optical element 2, to a second port 7 at a second side 5 of the optical component 1, through at least a portion of a second optical element 10. The optical component 1 further comprises a second optical channel 9 extending from a third port 11 at a first side 4 of the optical component 1, through at least a portion of the first optical element 2, to a fourth port 12 at the second side 5 of the optical component 1. The second optical element 10 is disposed over the first optical element 2 and the first and second optical elements 2, 10 are directly bonded to each other without an intervening adhesive, forming a first bonded structure 49. In other embodiments, optical element 10 may be formed by deposition techniques as described in FIGS. 1A-1D. With respect to the bonded structure 49, the first optical channel 3 extends at least partially through the bonded structure 49 between the first and second sides 4, 5, and the second optical channel 9 also extends at least partially through the bonded structure 49 between the first and second sides 4, 5, the second optical channel 9 including a first channel portion 9a extending from the first side 4 along a first direction D1 and a second channel portion 9b extending along a second direction D2.

Each optical channel 3, 9 has an index of refraction n1, which is larger than the index of refraction n2 of the surrounding cladding making up the optical elements 2, 10. In another embodiment, optical channels 3 and 9 may be formed with different materials with different indices of refraction. In one embodiment, one of layers 2a, 2b, 10a and 10b, may be formed with the material different from another layer material with a different index of refraction (e.g., in one embodiment, layer 2a could have an index of refraction of n2 and layer 2b could have an index of refraction of n2′). Electromagnetic radiation 43 is provided through the first and second optical channels 3, 9. Each optical channel 3, 9 can include one or more angled surfaces 44, which facilitates changing the direction of travel of the electromagnetic radiation. Each of the angled surfaces 44 is at an angle dependent on the direction the second direction D2 is to take with respect to the first direction D1. For example, each of the angled surfaces 44 can be positioned at an angle value within a range of 35-60 degrees. In one embodiment, one or more of the angled surfaces 44 is at an angle of approximately 45 degrees. In some embodiments, one or more of the angled surfaces 44 is a polished surface. In some embodiments, one or more of the angled surfaces 44 is a mirror.

As shown in FIGS. 2A and 2B, electromagnetic radiation 43 propagating in the first direction D1 in the first optical channel 3 is incident on a first angled surface 44a. The electromagnetic radiation 43 is reflected off the first angled surface 44a and continues to propagate through the first optical channel 3 in the second direction D2 different from the first direction D1. The second direction D2 is non-parallel to the first direction D1. FIGS. 2A and 2B show the second direction D2 is oriented approximately 90 degrees with respect to the first direction D1. In other embodiments, the second direction D2 can be oriented at other angles with respect to the first direction D1. For example, the first direction D1 could be along the z-axis and the second direction D2 could be along a direction falling within the xy-plane orthogonal to D1 (i.e., the z-axis). In such an embodiment, the second direction D2 can be oriented at any angle between 0 degrees and 359 degrees in the xy-plane. Similarly, in FIG. 2A, electromagnetic radiation 43 propagating in the first direction D1 in the second optical channel 9 is incident on a second angled surface 44b. The electromagnetic radiation 43 is reflected off the second angled surface 44b and continues to propagate through the second optical channel 9 in the second direction D2 different from the first direction D1. The first and third ports 6, 11 are separated or spaced apart by a first distance 58 along the first side 4 of the optical component 1, and the second and fourth ports 7, 12 are separated or spaced apart by a second distance 59 along an exterior surface (e.g., second side 5) of the optical component 1. In one embodiment, the first and second distances 58, 59 are different. In some embodiments, the first distance 58 can be less than the second distance 59. In other embodiments, the first distance 58 can be greater than the second distance 59. In various embodiments, the first and second distances 58, 59 represent first and second pitches (e.g., the first pitch can be from 50nm to 100 nm, 100 nm to 0.5 microns, 0.5 microns to 1 micron, from 5 microns to 10 microns, from 10 microns to 20 microns, from 20 microns to 30 microns, or any ranges formed by these values or larger or smaller values and in some examples, the second pitch can be from 50microns to 70 microns, from 70 microns to 90 microns, from 90 microns to 110 microns, or any ranges formed by these values or larger or smaller values) of the input ports 6, 11 and the output ports 7, 12, respectively. In FIG. 2A, the second side 5 of the optical component 1 is the side of the optical component 1 that is approximately perpendicular to the first side 4 of the optical component 1. In some embodiments the second side 5 can be disposed at other angles with respect to the first side 4 of the optical component 1. For example, the second side 5 can be at an angle between 30 degrees and 90 degrees relative to the first side 4 of the optical component 1. As an example, the second side 5 can be at an angle between 90 degrees and 150 degrees relative to the first side 4 of the optical component 1.

In another embodiment, and as shown in FIG. 2B, the first and third ports 6, 11 are separated by a distance 58 along the first side 4 of the optical component 1, and the second and fourth ports 7, 12 are separated by a second distance 59 along an exterior surface (e.g., the top side 13) of the optical component 1. In one embodiment, the first and second distances 58, 59 are different. In some embodiments, the first distance 58 can be less than the second distance 59. In other embodiments, the first distance 58 can be greater than the second distance 59. In various embodiments, the first and second distances 58, 59 represent first and second pitches of the input ports 6, 11 and the output ports 7, 12, respectively.

In the illustrated embodiments of FIGS. 2A and 2B, the optical channels 3, 9 can have one or multiple turns at any suitable angle. In some embodiments, two optical channels on the same layer can intersect or cross. The light in the intersecting channels will not interact with each other and will cross from one portion of the optical channel before the intersecting junction straight into the next portion of the optical channel on the other side of the intersecting junction without any loss of signal. These turns and intersections at least partially enable the overall routing of the signals and fanning out of the pitches from the input to the output. As described above, this fanning out of the pitch makes possible the use of different or arbitrary pitch emitters and receivers with a standard optical socket disposed at the output ports of the optical channels. A further advantage, as indicated in the illustrated embodiments, is the ability to place the inputs and outputs on any suitable input or output surface (e.g., at any suitable angle). Optical component 1 allows for the optical coupling of two devices at various orientations (due to the ability to decide where the input/output sides arc) and having different pitches.

In FIGS. 2A and 2B, the portions of each optical element 2, 10 outside of the optical channels 3, 9 comprise cladding or surrounding material. The surrounding material of optical element 2 is directly bonded to the surrounding material of optical 10 through bonding interface 62. Similarly, the optical channel 3 in FIG. 2A is formed in part through direct bonding through the bonding interface 62, and the optical channels 3, 9 in FIG. 2B are formed in part through direct bonding through the bonding interface 62.

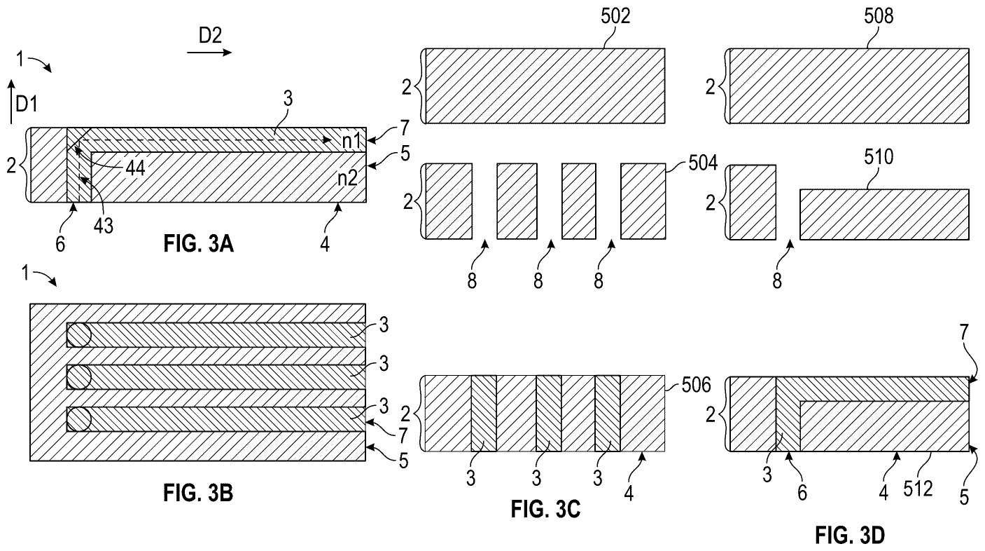

FIG. 3A illustrates an example optical channel that can be used in a directly bonded optical component. In FIG. 3A, the first optical element 2 comprises a single layer, as compared to the first optical element 2 in FIG. 1A, which comprises two layers, 2a and 2b. In FIG. 3A, the first optical channel 3, which can be an optical waveguide, is formed in the single layer of the first optical element 2 through a process such as etching. In some embodiments, the first optical channel 3 is formed using materials including semiconductor materials (e.g., silicon), inorganic dielectrics (e.g., silicon oxide, silicon nitride, silicon oxycarbonitride, silicon oxynitride, etc.), and organic dielectrics (e.g., polymers). In other embodiments, one or both of layer 2 and the first optical channel 3 are formed using optical materials, including organic or inorganic materials (e.g., ceramics and glasses like quartz, borosilicate, fused silica, etc. and specialized glass compositions as well as polymer materials like silicone, polycarbonate, acrylic). In other embodiments, materials supporting a portion of the light spectrum other than the visible spectrum (e.g., NIR, SWIR, etc.) may also be used. In some embodiments, the first optical channel 3 is formed using an etching process such as wet etching, dry etching, UV-laser-writing, etc.

The optical channel 3 has an index of refraction n1 and the material or cladding that comprises the optical element 2 outside of the optical channel 3 has an index of refraction n2, where n1 is greater than n2. In this configuration, electromagnetic radiation 43 propagates through the first optical channel 3 by entering the optical component 1 through a first port 6 at a first side 4 of the optical component 1, propagating through the first optical channel 3 in a first direction D1, and encountering an angled surface 44 such that the electromagnetic radiation 43 is reflected into a second direction D2 that is different from the first direction D1. In one embodiment, direction D1 may be in the vertical direction (e.g., along the z-axis) and direction D2 may be pointing in any direction along the xy-plane that is orthogonal to the z-axis. The angled surface 44 is at an angle dependent on the direction the second direction D2 is to take with respect to the first direction D1. The angled surface 44 can be positioned at an angle value within the range of 35-60 degrees. In one embodiment, the angled surface 44 is at an angle of approximately 45 degrees. In some embodiments, the angled surface 44 is a polished surface. In some embodiments, the angled surface 44 is a mirror. The electromagnetic radiation 43 then propagates through the first optical channel 3 in the second direction D2 and exits the optical component 1 through a second port 7 at a second side 5 of the optical component 1. This process of etching an optical channel entirely in a single layer of the optical element can be used to form a plurality of optical channels 3. FIG. 3B shows the top view of the optical component 1, which includes a plurality of optical channels 3.

FIGS. 3C and 3D show a depth view and a side view of a fabrication process of the same optical component 1, respectively. A first layer 2 is shown in steps 502, 508. The first layer 2 can comprise any suitable material such as semiconductor materials (e.g., silicon) and inorganic dielectrics (e.g., silicon oxide, silicon nitride, silicon oxycarbonitride, silicon oxynitride, etc.). In steps 504, 510, one or more trenches 8 can be formed by etching (e.g., wet etching or dry etching). Trenches 8 can be formed in a vertical direction (e.g., D1 or z-axis). Steps 504, 510 can comprise a two-step etching process, in which only vertical trenches or holes in direction D1 are formed (e.g., by etching) in first layer 2 and then trenches in direction D2 are formed (e.g., by etching) in layer 2. In steps 506, 512, a second suitable material is deposited in the one or more trenches 8, forming one or more optical channels 3. The depositing optical channel material could be a single-step deposition process. The second suitable material can comprise semiconductor materials (e.g., silicon) and inorganic dielectrics (e.g., silicon oxide, silicon nitride, silicon oxycarbonitride, silicon oxynitride, etc.). In other embodiments, one or both of layer 2 and the first optical channel 3 are formed using optical materials, including organic or inorganic materials (e.g., ceramics and glasses like quartz, borosilicate, fused silica, etc. and specialized glass compositions as well as polymer materials like silicone, polycarbonate, acrylic). In other embodiments, materials that transmit a portion of the light spectrum other than the visible spectrum (e.g., NIR, SWIR, etc.) can also be used.

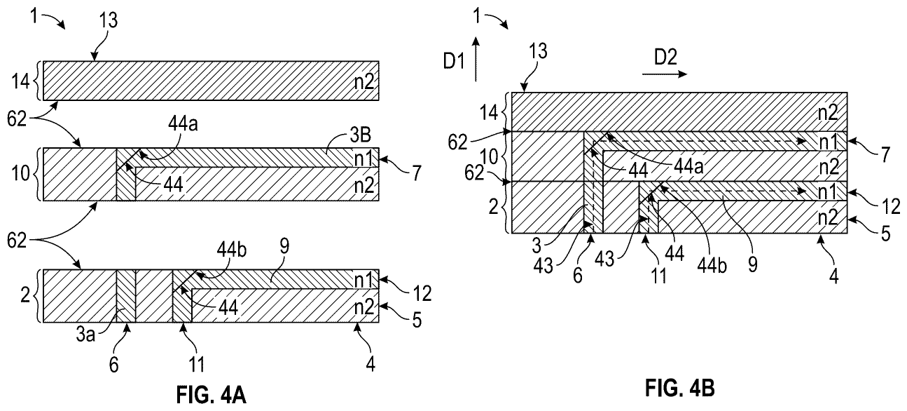

FIGS. 4A and 4B illustrate an optical component 1, according to one embodiment. FIG. 4A illustrates the optical elements 2, 10, 14 before being directly bonded along bonding interfaces 62. FIG. 4A shows an optical component 1 comprising three layers, wherein the first layer is a first optical element 2 and the second layer is a second optical element 10. The first optical element 2 comprises a first portion 3a of a first optical channel 3 and a second optical channel 9, and the second optical element 10 comprises a second portion 3b of the first optical channel 3. In one embodiment, the optical elements 2 and 10 are formed in the same or similar way as illustrated in FIGS. 3C and 3D. The second layer 10 is disposed over the first layer 2, and the first and second layers 2, 10 are directly bonded to one another without an intervening adhesive. A third layer 14, comprising a material that has an index of refraction n2 different from the index of refraction n1 of the first and second optical channels 3, 9, is disposed over the second layer 10 and is directly bonded to the second layer 10 without an intervening adhesive. In another embodiment, the material of optical element 14 can be deposited over optical element 10 to form the third layer 14. The material or cladding that comprises the optical elements 2, 10, 14 outside of the optical channels 3, 9 has an index of refraction n2, where n1 is greater than n2. In some embodiments, the optical elements 2, 10, 14, and the first and second optical channels 3, 9 are formed using materials including semiconductor materials (e.g., silicon), inorganic dielectrics (e.g., silicon oxide, silicon nitride, silicon oxycarbonitride, silicon oxynitride, etc.), and organic dielectrics (e.g., polymers). In other embodiments, one or more layers 2, 10, and 14 and first and second optical channels 3, 9 are formed using optical materials, including organic or inorganic materials (e.g., ceramics and glasses like quartz, borosilicate, fused silica, etc. and specialized glass compositions as well as polymer materials like silicone, polycarbonate, acrylic).

The first optical channel 3 extends between a first port 6 on the first side 4 of the optical component 1 and a second port 7 on the second side 5 of the optical component, and the second optical channel 9 extends between a third port 11 on the first side 4 of the optical component 1 and a fourth port 12 on the second side 5 of the optical component 1. In one embodiment, the second side 5 of the optical component is at the side of the optical component 1 that is non-parallel to the first side 4 of the optical component 1. In the configuration shown in FIG. 4B, electromagnetic radiation 43 propagates through the first optical channel 3 by entering the optical component 1 through the first port 6 in a first direction D1, encounters a first angled surface 44a such that it is reflected into a second direction D2 different from the first direction D1, and exits the optical component 1 through the second port 7. Similarly, electromagnetic radiation 43 propagates through the second optical channel 9 by entering the optical component 1 through the third port 11 in a first direction D1, impinges upon a second angled surface 44b such that it is reflected into a second direction D2 different from the first direction D1 and exits the optical component 1 through the fourth port 12. Each of the angled surfaces 44a, 44b is at an angle dependent on the direction the second direction D2 is to take with respect to the first direction D1. For example, each of the angled surfaces 44a, 44b can be positioned at an angle value within the range of 35-60 degrees. In one embodiment, each of the angled surfaces 44a, 44b is at an angle of approximately 45 degrees. In some embodiments, one or more of the angled surfaces 44a, 44b is a polished surface. In some embodiments, one or more of the angled surfaces 44a, 44b is a mirror. In one embodiment, direction D1 may be in the vertical direction (e.g., along the z-axis) and direction D2 may be pointing in any direction along the xy-plane that is orthogonal to Z axis.

The embodiment illustrated in FIGS. 4A and 4B can provide operational or performance advantages generally similar to or the same as the embodiments shown in FIGS. 2A and 2B. An additional benefit of this embodiment is that it is relatively easy to manufacture because it involves etching and forming an optical channel in a single layer that can then be directly bonded to other layers that have been similarly etched and filled.

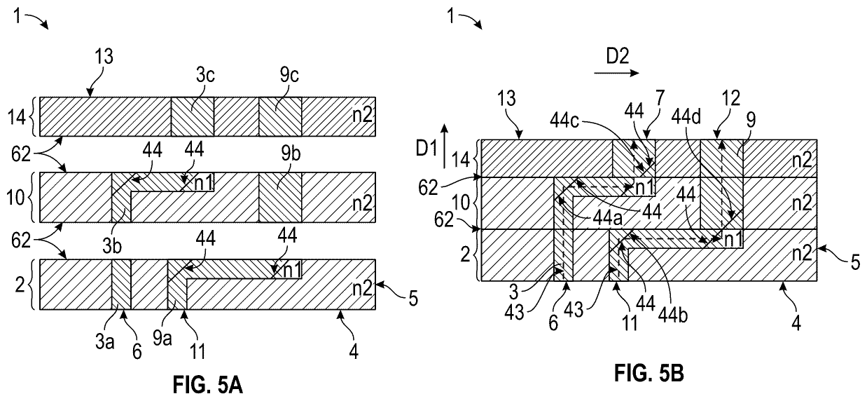

FIG. 5A illustrates optical elements 2, 10, 14 before being directly bonded along bonding interfaces 62 and FIG. 5B shows the directly bonded optical component 1, according to one embodiment. As shown in FIG. 5A, an optical component comprises three layers, wherein the first, second, and third layers correspond to the first, second, and third optical elements 2, 10, 14, respectively. The first optical element 2 comprises a first portion 3a of a first optical channel 3 and a first portion 9a of a second optical channel 9. The second optical clement 10 comprises a second portion 3b of the first optical channel 3 and a second portion 9b of the second optical channel 9. The third optical element 14 comprises a third portion 3c of the first optical channel 3 and a third portion 9c of the second optical channel 9.

In FIGS. 5A and 5B, the third layer 14 is disposed over the second layer 10, and the second layer 10 is disposed over the first layer 2. The first layer 2 is directly bonded to the second layer 10 along a bonding interface 62 and the second layer 10 is directly bonded to the third layer 14 along a bonding interface 62 without an intervening adhesive. More specifically, as shown in FIGS. 5A and 5B, the portions of each optical element 2, 10, 14 outside of the optical channels 3, 9 can serve as a cladding or surrounding material. The surrounding material of optical element 2 is directly bonded to the surrounding material of optical element 10 through bonding interface 62, and the surrounding material of optical clement 10 is directly bonded to the surrounding material of optical element 14 through bonding interface 62. Additionally, the first portion 3a of the first optical channel 3 is directly bonded through bonding interface 62 to the second portion 3b of the first optical channel 3, and the second portion 3b is directly bonded through bonding interface 62 to the third portion 3c of the first optical channel 3. Similarly, the first portion 9a of the second optical channel 9 is directly bonded to the second portion 9b through bonding interface 62, and the second portion 9b of the second optical channel 9 is directly bonded to the third portion 9c of the second optical channel 9 through bonding interface 62. The bonding interface 62 between the portions of each optical element 2, 10, 14 outside of the optical channels 3, 9 (e.g., the materials with an index of refraction n2) can be, but need not be, transparent. However, the bonding interface 62 between the optical channels is optically transparent, allowing for the transmission of light with little-to-no refraction or reflection of the light 43 (e.g., the interface between the optical channels is smooth, seamless, and transparent, which allows for loss-free transmission of the light 43).

The first optical channel 3 extends between a first port 6 on the first side 4 of the optical component 1 and a second port 7 on the top side 13 of the optical component 1, and the second optical channel 9 extends between a third port 11 on the first side 4 of the optical component 1 and a fourth port 12 on the top side 13 of the optical component 1. In one embodiment, the second portion 3b of the first optical channel 3 further comprises two angled surfaces 44a, 44c and the first portion 9a of the second optical channel 9 further comprises two angled surfaces 44b, 44d. In the configuration shown in FIG. 5B, electromagnetic radiation 43 propagates through the first optical channel 3 by entering the optical component 1 through the first port 6 in a first direction D1, impinges upon a first angled surface 44a such that it is reflected into a second direction D2 different from the first direction D1, impinges upon a third angled surface 44c such that it is reflected into a third direction D3 different from the second direction D2, and exits the optical component 1 through the second port 7. Similarly, electromagnetic radiation 43 propagates through the second optical channel 9 by entering the optical component 1 through the third port 11 in a first direction D1, impinges upon a second angled surface 44b such that it is reflected into a second direction D2 different from the first direction D1, impinges upon a fourth angled surface 44d such that it is reflected into a third direction D3 different from the second direction D2, and exits the optical component 1 through the fourth port 12.

The embodiment illustrated in FIGS. 5A and 5B, provides similar operational or performance advantages as the embodiment shown in FIGS. 4A and 4B. The embodiment in FIGS. 4A and 4B would facilitate interfacing the optical component 1 with additional optical components or devices below and to the side of the optical component 1. The embodiment of FIGS. 5A and 5B, however, demonstrate that the optical channels can incorporate multiple turns, crosses, junctions, and intersections to direct the electromagnetic radiation 43 from input ports on the first side 4 of the optical component 1 to output ports on the top side 13 of the optical component 1, facilitating interfacing the optical component 1 with additional optical components or devices below and above optical component 1.

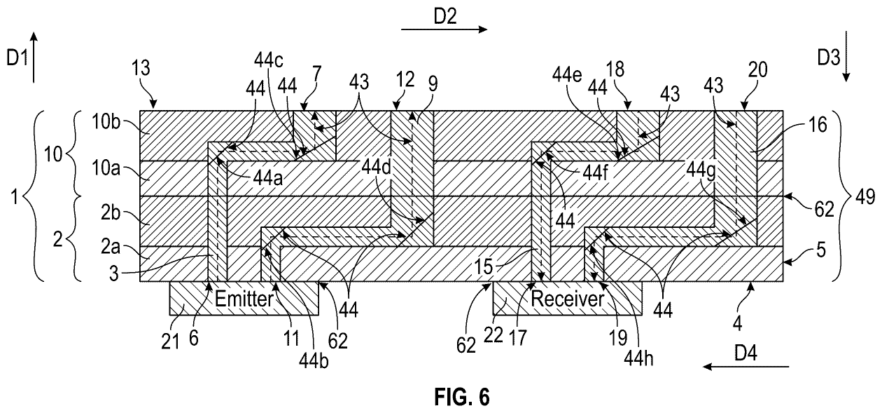

FIG. 6 illustrates an optical component 1 comprising a stack of optical elements 2, 10 defining multiple optical channels 3, 9, 15, 16, according to one embodiment. Optical channels 3 and 9 are the same as or generally similar to the channels 3 and 9 illustrated in FIG. 2B. Optical channels 15 and 16 are also the same as or generally similar to the channels 3 and 9 illustrated in FIG. 2B. More specifically, the optical component 1 comprises a first optical channel 3 extending from a first port 6 at a first side 4 of the optical component 1, through the bonded structure 49, to a second port 7 at the top side 13 of the optical component 1 (i.e., the first optical channel 3 extends through the bonded structure 49 between the first and second ports 6, 7). The bonded structure 49 comprises the second optical element 10 disposed over the first optical element 2 such that the first and second optical elements 2, 10 are directly bonded to each other without an intervening adhesive. The optical component 1 further comprises a second optical channel 9 extending from a third port 11 at a first side 4 of the optical component 1, through the bonded structure 49, to a fourth port 12 at the top side 13 of the optical component 1 (i.e., the second optical channel 9 extends through the bonded structure 49 between the third and fourth ports 11, 12). The optical component 1 further comprises a third optical channel 15 extending from a fifth port 17 at the first side 4 of the optical component 1, through the bonded structure 49, to a sixth port 18 at the top side 13 of the optical component (i.e., the third optical channel 15 extends at least partially through the bonded structure 49 between the fifth and sixth ports 17, 18), and a fourth optical channel 16 extending from a seventh port 19 at the first side 4 of the optical component 1, through the bonded structure 49, to an eighth port 20 at the top side 13 of the optical component 1 (i.e., the fourth optical channel 16 extends through the bonded structure 49 between the seventh and eighth ports 19, 20).

In one embodiment, the first and second optical channels 3, 9 are direct bonded to a first optical device 21 and the third and fourth optical channels 15, 16 are direct bonded to a second optical device 22. In one embodiment, the first optical device 21 is an emitter, such as a vertical-cavity surface-emitting laser (VCSEL), edge-emitting laser (EEL), photonic crystal surface-emitting laser (PCSEL), laser diode, or LED source (e.g., a low-power LED, microLED, OLED, micro-OLED, etc.), a modulator, an electro-optic modulator, a coupler, etc. In one embodiment, the second optical device 22 is a receiver, such as a photodiode or complementary metal-oxide semiconductor (CMOS) sensor, a photodetector, a modulator, a coupler, etc. In some embodiments, the first and/or second devices may be part of photonic integrated circuits (PIC) or electronic integrated circuits (EIC) of the optical system.

As shown in FIG. 6, electromagnetic radiation 43 is provided through the first and second optical channels 3, 9. Each optical channel 3, 9 can include one or more angled surfaces 44, which facilitate changing the direction of propagation of the electromagnetic radiation 43. In FIG. 6, electromagnetic radiation 43 is generated by the first optical device 21 and the electromagnetic radiation 43 enters the first port 6 of the first optical channel 3. The electromagnetic radiation 43 is transmitted through the first optical channel 3 in a first direction D1 until it is incident on a first angled surface 44a. The electromagnetic radiation 43 is then reflected from the first angled surface 44a and is transmitted in a second direction D2 different from the first direction D1 until it is incident on a third angled surface 44c. The electromagnetic radiation 43 is then reflected from the third angled surface 44c and is transmitted in a third direction that is the same as the first direction D1, but different from the second direction D2, and exits the optical component 1 through the second port 7. The electromagnetic radiation 43 is transmitted in the same manner through the second optical channel 9. In some embodiments, the first and third directions can be the same. In some embodiments, the third direction can be different from the first direction.

As shown in FIG. 6, electromagnetic radiation 43 can also enter the optical component 1 through the sixth port 18, corresponding to the third optical channel 15. The electromagnetic radiation 43 propagates in a first direction D3 until it is incident on a fifth angled surface 44e and is reflected off the fifth angled surface 44c into a second direction D4 different from the first direction D3. The electromagnetic radiation 43 propagates in this second direction D4 until it is incident on a sixth angled surface 44f and reflected off the sixth angled surface 44f into a third direction D3 different from the second direction D4. The electromagnetic radiation 43 then exits the optical component 1 through the fifth port 17 into a second optical device 22. The electromagnetic radiation 43 is transmitted in the same manner through the fourth optical channel 16 as it enters the eighth port 20, is reflected off the seventh and eighth angled surfaces 44g, 44h, and exits the seventh port 19 into the second optical device 22. In some embodiments, the first and third directions can be the same. In some embodiments, the third direction can be different from the first direction.

In some embodiments, the optical channels 3 and 9 of optical component 1, as illustrated in FIG. 6, can operate or function independently of optical channels 15 and 16, such that the signals (e.g., electromagnetic radiation 43) can be emitted through optical channels 3, 9 to an external device, and signals (e.g., electromagnetic radiation 43) can be received from the same external device (or a different device) through optical channels 15, 16. In other embodiments, the emitted signal can be processed or otherwise modified by the external device to which optical component 1 is connected (not shown) and the processed or modified signal can be sent back to the receiver.

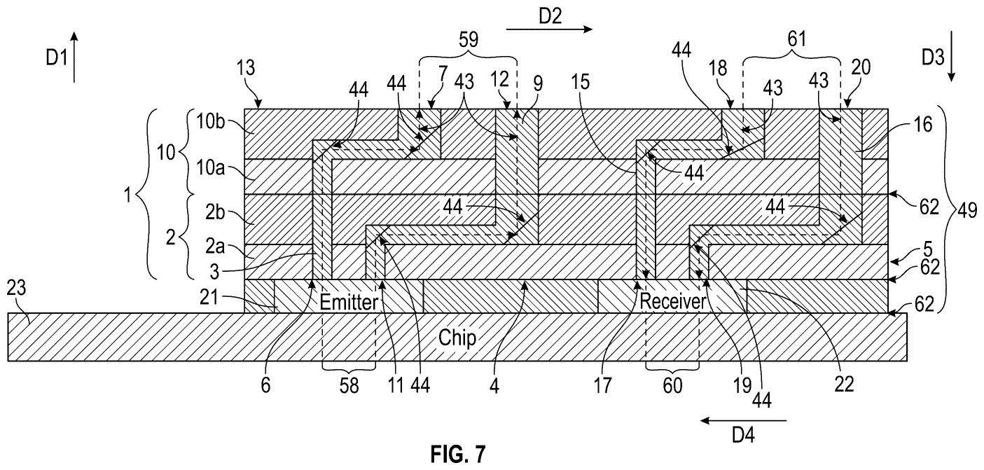

In one embodiment, and as illustrated in FIG. 7, the first and second optical devices 21, 22 are bonded to a first die 23. In one embodiment, the bond between the first optical device 21 and the first die 23 and the bond between the second optical device 22 and the first die 23 are hybrid bonds, e.g., dielectric-to-dielectric and conductor-to-conductor direct bonds. In one embodiment, the first and second optical device 21, 22 are bonded to the first die 23 using hybrid bonding or thermocompression. In some embodiments, the first die 23 can be a dielectric or semiconductor substrate. In other embodiments, the first die 23 can be a processor die, controller chip, or a driver chip that controls the emission of light from the emitter and which can route the received light from the receiver to the appropriate circuits or to other devices. In some embodiments, the first die 23 can be an electronic integrated circuit (EIC) or a die that can provide Serializer/Deserializer (SerDes) functionality and act as part of an I/O interface between optical signals and electrical signals within the optical component. In some embodiments, the first die 23 can be an interposer. In some other embodiments, the first die 23 can be attached to an interposer, to another die or a substrate using any suitable technique. For example, the first die 23 can be attached using flip chip, micro-bumping, wire bonding, adhesive bonding (e.g., die attach film or past), hybrid bonding, etc. In one embodiment, the first and third ports 6, 11 are separated by a first distance 58, the second and fourth ports 7, 12 are separated by a second distance 59, the fifth and seventh ports 17, 19 are separated or spaced apart by a third distance 60, and the sixth and eighth ports 18, 20 are separated or spaced apart by a fourth distance 61. In one embodiment, the first distance 58 is different from the second distance 59, and the third distance 60 is different from the fourth distance 61. In one embodiment, the first distance 58 is less than the second distance 59, and the third distance 60 is less than the fourth distance 61. In one embodiment, the first, second, third, and fourth distances 58, 59, 60, 61 are first, second, third, and fourth pitches.

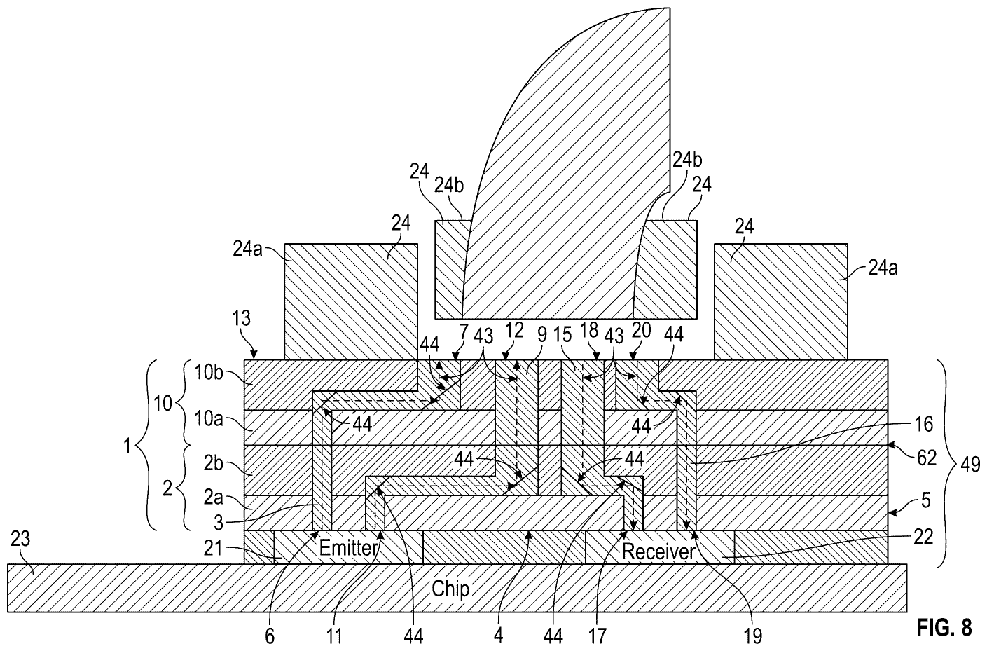

FIG. 8 illustrates another embodiment of the optical component 1 shown in FIGS. 6 and 7. In FIG. 8, the optical component 1 comprises a first optical device 21, a second optical device 22, first and second optical channels 3, 9, optically coupled to the first optical device 21, and third and fourth optical channels 15, 16, optically coupled to the second optical device 22. The first and second optical devices 21, 22 are disposed on a die 23 (e.g., a dielectric or semiconductor substrate). In some examples, the second optical devices 21, 22 can be directly bonded to the die 23. In other examples, the second optical devices 21, 22 can be monolithically fabricated on the die 23.

In some cases, the first optical device 21 can be an optical emitter (e.g., a laser diode, or a LED) and the second optical device 22 can be an optical receiver (e.g., a photodetector such as a photodiode). The first and second optical channels 3, 9, can be optical output waveguides configured to receive light emitted by the first optical device 21 and output the received light from the second and fourth 7, 12 ports. The third and the fourth optical channels 15, 16, can be input optical waveguides configured to receive light via the sixth and the eighth ports 18, 20 and provide the light received to the second optical device 22.

The optical component 1 further comprises an adapter assembly 24 configured to optically couple to the second, fourth, sixth, and eighth ports 7, 12, 18, 20 of the optical component 1. In one embodiment, the adapter assembly 24 provides an optical connection between the optical channels 3, 9, 15, 16 and an external element (not shown). In some embodiments the adapter assembly 24 may comprise one or more optical elements (not shown) configured to improve optical coupling between the optical channels 3, 9, 15, 16 and the external element. For example, the adapter assembly 24 may include one or more lenses (e.g., microlenses) that redirect light rays received from the external elements to the second, fourth, sixth, and eighth ports 7, 12, 18, 20 and vice versa. As another example, the adapter assembly 24 can include one or more coupling elements (e.g., grating couplers) that couple received light from the second, fourth, sixth, and eighth ports 7, 12, 18, 20 to the external device and vice versa. In one embodiment, the adapter assembly 24 facilitates the coupling between at least the first optical channel 3 and an optical fiber or a plurality of multiple optical fibers or optical fiber cables. In some examples, the adapter assembly 24 may align a core of the optical fiber (e.g., a fiber core or external fiber core) with the ports 7, 12, 18, 20 such that light output by the optical channels 3, 9, 15, 16 is directly coupled to the core. In another embodiment, the adapter assembly 24 may optically couple a multicore fiber to the ports 7, 12, 18, 20. For example, the adapter assembly 24 may align four individual cores of the multicore optical fiber to the ports 7, 12, 18, 20, respectively, to provide mutual optical coupling between respective optical channels and cores. In some examples, the adapter assembly 24 may align each core of the plurality of multiple optical fibers with one of the ports 7, 12, 18, 20 such that light outputted by the optical channels 3, 9, 15, 16 is directly coupled to the core.

In some embodiments, the adapter assembly 24 may comprise a first adapter element 24a disposed on the top side 13 of the optical component 1 and a second adapter element 24b mechanically coupled to the first adapter element 24a. In some cases, the second adapter element 24b can be a removable element. In some cases, the second adapter element 24b is connected to the external element.

The illustrated embodiment of FIG. 8 shows an example of how the optical component can be used as a modular component within device packaging. Light can be transmitted from an emitter through multiple inputs where the inputs can be arranged to have a narrow or arbitrary pitch. The light can propagate through multiple optical waveguides and exit through multiple output ports that can be arranged to have a larger pitch, allowing for subsequent coupling of the output ports to an adapter assembly. Such a configuration facilitates the coupling of light from the output ports to another device without requiring the direct and permanent attachment of fibers to the optical component itself. The optical component can be readily coupled to external devices using standard connectors that can connect to the adapter assembly of the optical component. Additionally, this configuration allows for the possibility of receiving optical signals from an external device coupled to the optical component via the adapter assembly, such that the optical signals are transmitted through the ports at the top side of the optical component, propagate through the optical waveguides, and are received by the optical receiver. The optical signals can then continue to be transmitted as optical signals to other devices or otherwise manipulated, or they can be converted into electrical signals.

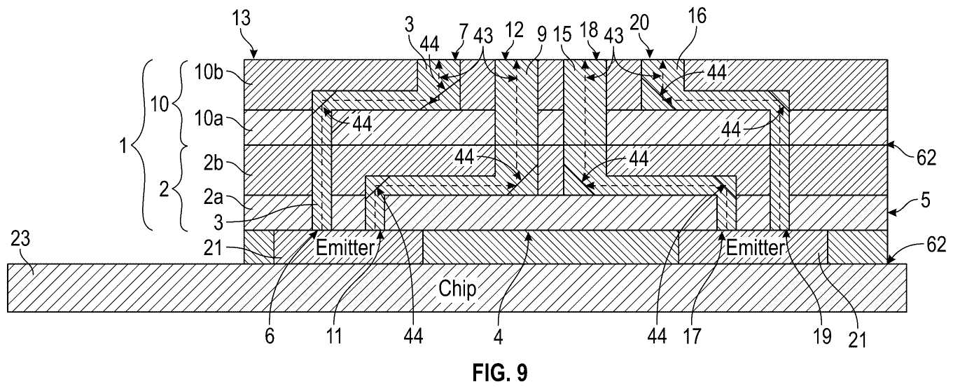

In FIG. 9, the optical component 1 comprises first and second optical elements 2, 10; first, second, third, and fourth optical channels 3, 9, 15, 16; a first die 23; and a plurality of first optical devices 21, in one embodiment. The plurality of first optical devices 21 can be hybrid bonded to the first die 23. In one embodiment, the plurality of emitters 21 is a large array of light sources. For example, the large array of light sources can comprise VCSELs, EELS, PCSELs, or LEDs (e.g., low-power LEDs, micro-LEDs, OLEDs, etc.). In another embodiment, the large array of light sources is coupled with other large arrays of light sources. In one embodiment, the coupling of large arrays of light sources results in the creation of a display (not shown). In such an embodiment, the optical channels 3, 9, 15, 16 can fan out from the small pitches of the plurality of emitters 21 to larger pitches of a plurality of pixels on the display. In another embodiment, the optical channels 3, 9, 15, 16 can be configured to connect large pitches of the plurality of emitters 21 to smaller pitches of a plurality of pixels on the display. The smaller pitches can be approximately 0.5 microns. In some embodiments, the smaller pitches can be approximately 50 nm to 100 nm, 50 nm to 500 nm, 50 nm to 1000nm, 100 nm to 500 nm, 100 nm to 1000 nm, or any ranges formed by these values or larger or smaller values. The larger pitches could be between approximately 50 microns and 500 microns, or any ranges formed by these values or larger or smaller values. Additionally, the ports could be as small as 0.1 microns to as large as 100 microns in size. In some embodiments, the ports could be smaller than 0.1 microns in size.

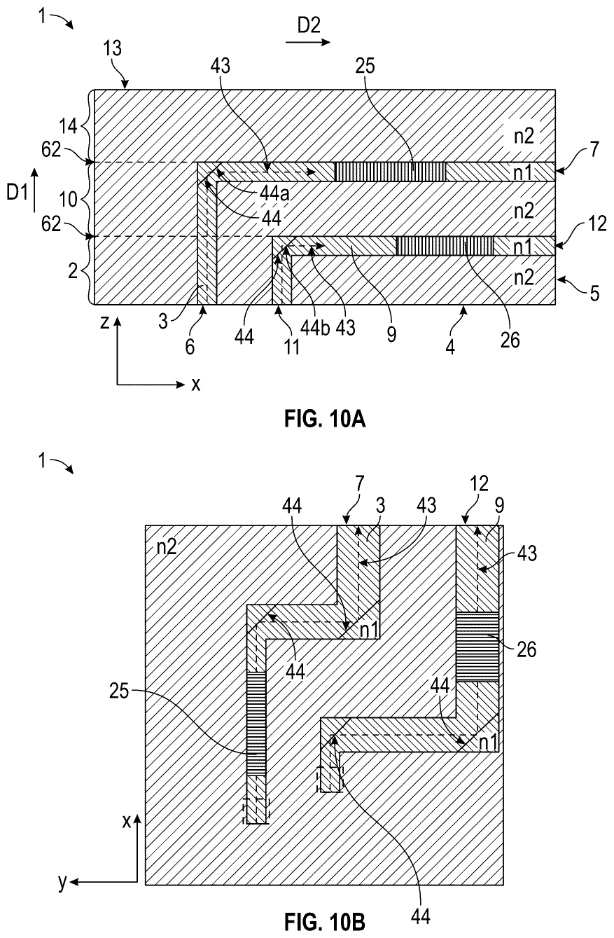

FIGS. 10A and 10B illustrate side and top cross-sectional views of an optical component 1, respectively, according to one embodiment. The optical component 1 may comprise one or more dielectric layers bonded together. In some examples, the optical component 1 may comprise three dielectric layers where an individual dielectric layer comprises at least a vertical (e.g., extending along z-axis) or a horizontal (e.g., extending along x-axis or along any direction in the xy-plane) optical waveguide region. When these three layers are bonded together, the optical waveguide regions form at least one optical channel (or waveguide) optically connecting an input port to an output port of the optical component 1. In some cases, a dielectric layer may comprise an optical channel formed by one or more optical waveguide regions. In some embodiments, at least one optical waveguide region may comprise a wavelength selective region configured to provide different optical paths for at least two different wavelengths. As shown in FIGS. 10A-B, the optical component 1 comprises a first optical channel 3 extending through a first optical element 2 and a second optical element 10. The first optical channel 3 can extend from a first port 6 at the first side 4 of the optical component 1 to a second port 7 on the second side 5 of the optical component 1. The optical component 1 further comprises a second optical channel 9 extending through the first optical element 2, wherein the second optical channel 9 can extend from a third port 11 at the first side 4 of the optical component 1 to a fourth port 12 on the second side 5 of the optical component 1.

The first and the second optical channels 3, 9, comprise a first and a second optical gratings 25, 26, respectively. The first optical channel 3 further comprises a first angled surface 44a, which guides the transmission of electromagnetic radiation 43 from a first direction D1 to a second direction D2 different from the first direction D1 and through the first grating 25 in the first optical channel 3. The second optical channel 9 further comprises a second angled surface 44b, which guides the transmission of electromagnetic radiation 43 from a first direction D1 to a second direction D2 different from the first direction D1 and through the second grating 26 in the second optical channel 9. In one embodiment, the first and second gratings 25, 26 are Bragg gratings. In some embodiments, the first and second gratings 25, 26 can be used as filtering devices to selectively transmit electromagnetic radiation signals of specific wavelengths. For example, the first grating 25 (or the second grating 26), may be configured to reflect light having a wavelength within a reflection bandwidth of the first grating 25 and transmit light wavelengths outside of the reflection bandwidth. In various embodiments, the first and the second gratings 25, 26 can have the same or different spectral responses. Advantageously, including optical gratings (or other wavelength selective optical components) can enable tailoring the optical spectrum of light transmitted via the optical component 1 and reduce the number of optical components in the external optical devices that are optically connected via the optical component 1. In various implementations, the first grating 25 (or the second grating 26) may be configured as a band pass or band stop optical filters. In some cases, an optical channel may include two or more gratings having different spectral transmissions. The optical component 1 may serve a dual role as an optical interconnection and optical filter in certain optical systems (e.g., wavelength multiplexed optical systems).

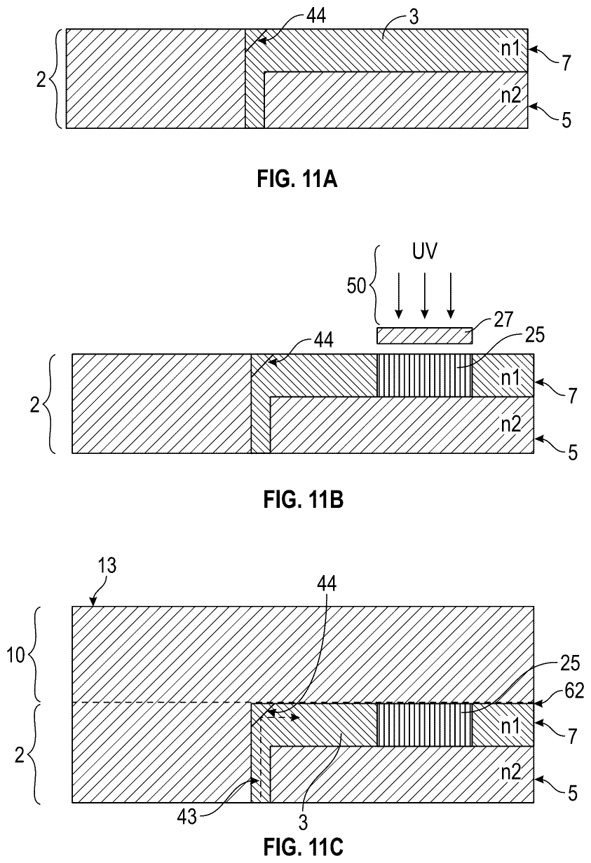

FIGS. 11A-C show one example of how a first Bragg grating 25 can be fabricated on a first optical channel 3 in the optical component 1. For example, a first dielectric layer 2 of an optical component 1 may include a first optical channel 3 comprising a vertical waveguide region and a horizontal waveguide region. In some cases, a top surface of the first dielectric layer may comprise a top surface of the horizontal waveguide region. In some other cases, the horizontal waveguide region may be positioned below the top surface of the dielectric layer 2. In various embodiments the dielectric layer 2 and the horizontal waveguide region therein may be configured to allow optical access to the horizontal waveguide region via the top surface. In some cases, an optical grating may be formed in the horizontal waveguide region by direct optical writing, illumination via an optical mask, or forming an etched periodic structure. In one embodiment, the first optical channel 3 is an optical waveguide. In one embodiment, the first optical channel 3 is a fabricated glass waveguide. In some embodiments, the fabricated glass waveguide can be a silica waveguide. Although the fabricated waveguide material has been described as glass or silica, other materials could be used. The waveguide can have an index of refraction n1, and the portions of the optical element 10 outside of the first optical channel 3 (e.g., the cladding) can have an index of refraction n2, where n1 is greater than n2. The silica waveguide can be doped (e.g., FIG. 11A) in some embodiments to facilitate the alteration of its index of refraction to form a Bragg grating. After the doped silica waveguide has been formed (e.g., FIG. 11A), a phase mask 27 and UV illumination 50 are used to form the Bragg grating 25 on the silica waveguide 3 (e.g., FIG. 11B). After the Bragg grating 25 has been formed, a second dielectric layer 10 of the optical component 1, comprising a material with an index of refraction n2, is directly bonded to the first dielectric layer 2 (e.g., FIG. 11C). In another embodiment, the Bragg grating 25 is formed on the silica waveguide 3 using a process comprising direct writing using a femtosecond laser. In another embodiment, the Bragg grating 25 is formed on the silica waveguide 3 using a process comprising UV interference patterns.

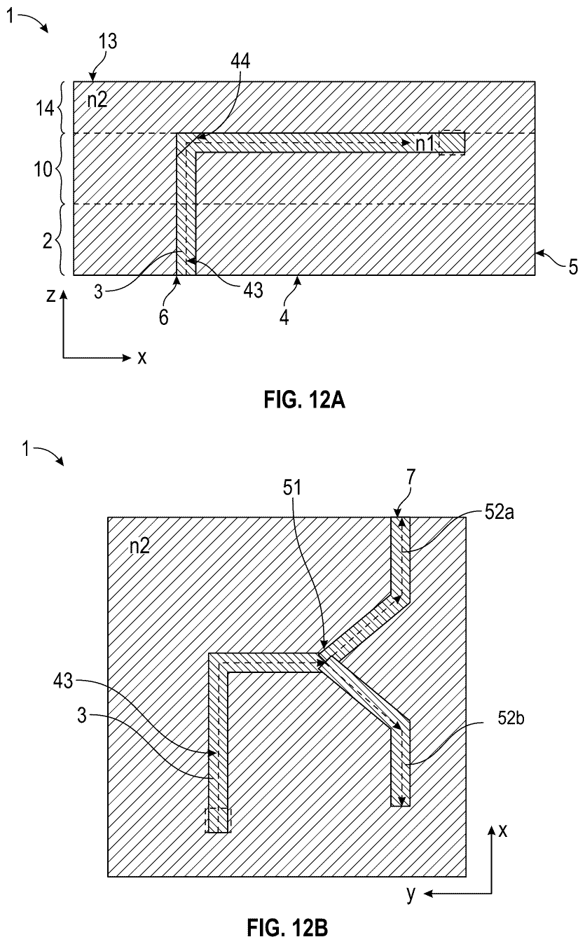

FIGS. 12A and 12B illustrate side and top cross-sectional views of an optical component 1, respectively, according to one embodiment. The optical component 1 may comprise one or more dielectric layers bonded together. In some examples, the optical component 1 may comprise three dielectric layers where an individual dielectric layer comprises at least a vertical (e.g., extending along z-axis) or a horizontal (e.g., extending along x-axis) optical waveguide region. When these three layers are bonded together, the optical waveguide regions form at least one optical power divider optically connecting an input port to two or more output ports of the optical component 1. The optical component 1 shown in FIG. 12A, comprises a first optical channel 3 with index of refraction n1, extending from a first port 6 at the first side 4 of the optical component 1, through the first and second dielectric layers 2, 10, and an optical power divider (FIG. 12B) formed in a third dielectric layer 14. The optical power divider comprises a Y-junction 51 and two branching optical channels 52a, 52b where the input port of the Y-junction 51 is optically coupled to the first optical channel 3. The third dielectric layer 14 is disposed over the second dielectric layer 10 and comprises a material having an index of refraction n2. The Y-junction 51 is configured to divide the electromagnetic radiation (light) 43 transmitted through the first optical channel 3 into a first-branching optical channel 52a and a second-branching optical channel 52b, wherein at least one of the branching optical channels (e.g., 52a) extends through the second optical element 10 to a second port 7 located at a second side 5 of the optical component 1.

In one embodiment, the Y-junction 51 is configured to split the electromagnetic radiation 43 equally between the two branching optical channels 52a and 52b. In another embodiment, the Y-junction 51 is configured to asymmetrically split the electromagnetic radiation between the two branching optical channels 52a and 52b. In one embodiment, the amount of electromagnetic radiation transmitted through optical channel 52a is greater than the amount of electromagnetic radiation transmitted through optical channel 52b. In one embodiment, the amount of electromagnetic radiation transmitted through optical channel 52a is less than the amount of electromagnetic radiation transmitted through optical channel 52b. In some embodiments, the Y-junction 51 acts as a power splitter. In such an embodiment the electromagnetic radiation 43 is transmitted through the first optical channel 3, which can be a straight optical waveguide. The electromagnetic radiation 43 is then divided between the first and second-branching optical channels 52a, 52b by the Y-junction 51. In another embodiment, the Y-junction 51 acts as an optical power combiner, such that electromagnetic radiation received via the first and second-branching optical channels 52a, 52b, are combined by the Y-junction 51 to generate the electromagnetic radiation 43 in the first optical channel 3. The combined electromagnetic radiation 43 is transmitted through the first optical channel 3 and is output via the port 6.

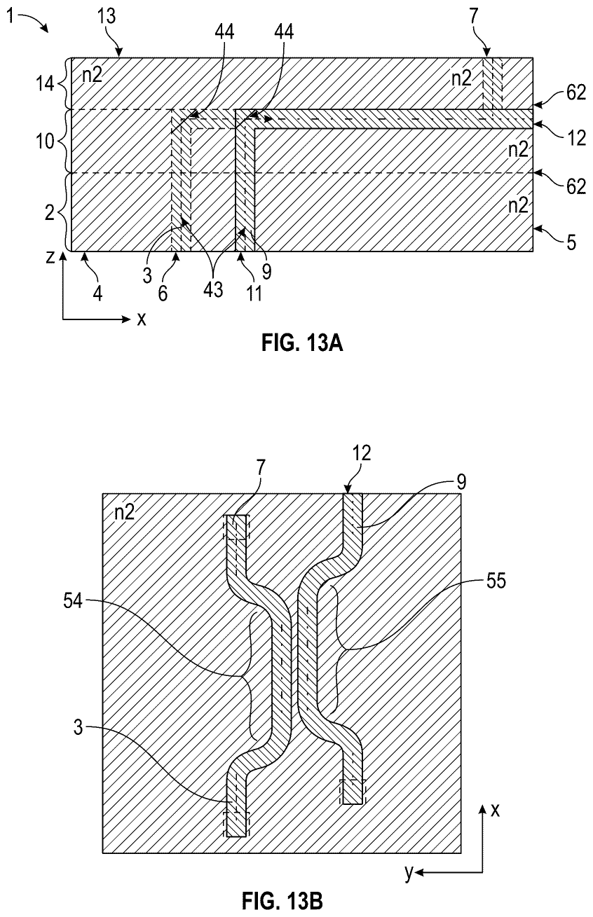

FIG. 13A illustrates an optical component 1, according to one embodiment. The optical component 1 may comprise one or more dielectric layers directly bonded together through bonding interfaces 62. In some examples, the optical component 1 may comprise three dielectric layers where an individual dielectric layer comprises at least a vertical (e.g., extending along z-axis) or a horizontal (e.g., extending along x-axis) optical waveguide region. When these three layers are bonded together, the optical waveguide regions form at least one directional optical coupler optically connecting one or more input ports to one or more output ports of the optical component 1.

The optical component 1 shown in FIG. 13A, comprises a first optical channel 3 extending from a first port 6 at the first side 4 of the optical component 1 through the first, second, and third dielectric layers 2, 10, 14 to a second port 7 at the top side 13 of the optical component 1. The optical component 1 further comprises a second optical channel 9 extending from a third port 11 at the first side 4 of the optical component 1 through the first and second optical elements 2, 10 to the fourth port 12 at the second side 5 of the optical component 1, which is non-parallel to the first and top sides 4, 13 of the optical component 1. A first waveguide portion 54 of the first optical channel 3 and a second waveguide portion 55 of the second optical channel 9 in the second dielectric layer 10 are optically coupled (e.g., side coupled) to form a directional coupler 53 as shown in FIG. 13B. FIG. 13B illustrates the first waveguide portion 54 of the first optical channel 3, extending through the second, and the second waveguide portion 55 of the second optical channel 9, extending through the dielectric layer 10. In some cases, the first waveguide portions 54 can be substantially parallel to the second waveguide portion 55. In some examples, a lateral distance between the first waveguide portion 54 and second waveguide portion 55 along a direction parallel to a major surface of the second layer 10 and perpendicular to the first and/or the second waveguide portions 54, 55 (e.g., along y-axis), can be configured to allow mutual optical power transfer between the first and second waveguide regions 54, 55, via evanescent coupling. In some cases, the lateral distance between the first waveguide portion 54 and second waveguide portion 55 may be determined based at least in part on the wavelength of light transmitted through the optical component 1.

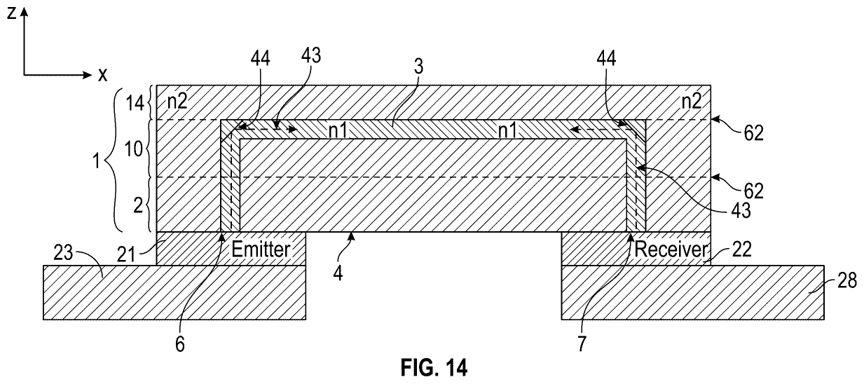

FIG. 14 illustrates two optical devices optically interconnected by an optical component 1, according to one embodiment. The optical component 1 may comprise one or more dielectric layers directly bonded together. In some examples, the optical component 1 may comprise three dielectric layers where an individual dielectric layer comprises at least a vertical (e.g., extending along z-axis) or a horizontal (e.g., extending along x-axis) optical waveguide region. In some embodiments, these three layers are directly bonded, forming at least one optical channel (or waveguide) which optically connects an input port to an output port of the optical component 1. The optical component 1 comprises a first optical channel 3 extending from a first port 6 at a first side 4 to a second port 7 at the first side 4 of the optical component 1. More specifically, the embodiment in FIG. 14 allows an optical signal to be emitted and received along the same side 4 of the optical component 1. In this embodiment, optical component 1 serves as an optical bridge to connect adjacent elements or devices through a bridging optical channel (or waveguide). The optical bridge is an advantage in such devices because it is a manufacturable way to create high speed chip-to-chip optical communications, etc.

In FIG. 14, the first optical channel 3 extends through the first and second dielectric layers 2, 10. In some cases, the first port 6 and the second port 7 of the optical component 1 may be optically coupled to the first and second optical devices 21, 22, respectively. In some embodiments, a first region of a bottom surface of the optical component 1, comprising the first port 6, may be directly bonded to a top surface of the first optical device 21 and a second region of a bottom surface of the optical component 1, comprising the second port 7, may be directly bonded to a top surface of the second optical device. In some embodiments, a direct bond between a top surface of the first optical device 21 (or the second optical device 22) and a region of the bottom surface of the optical component 1 may comprise a hybrid bond (e.g., a bond including at least one dielectric-to-dielectric and one metal-to metal bonds). In some cases, the first optical device 21 (or the second optical device 22) may comprise an optical element (e.g., an active or passive optical device) disposed on a substrate, die, chip, package or the like. In some cases, the optical element may be directly bonded to the substrate, die, chip, package or the like. In some examples, the optical element may be integrated or fabricated (e.g., monolithically) on the substrate, die, chip, package or the like. In other examples, the first optical device can be an optical emitter (e.g., a laser, laser diodes, LED, etc.) 21 bonded to a first element (e.g., a first die 23), and the second optical device can comprise an optical receiver 22 (e.g., a photodetector) bonded to a second element (e.g., a second die 28). In this way, the first optical channel 3 is configured to transmit an electromagnetic signal 43 (e.g., an optical signal) from the emitter 21 to the receiver 22. In some embodiments, each of the first and the second optical devices 21, 22 may include an optical transceiver configured to transmit and receive optical signals. In these embodiments, one or more optical channels of the optical component 1 may optically connect the two transceivers. In some examples, a single channel may transmit light from the first transceiver to the second transceiver and vice versa. In some examples, a first channel may transmit light from the first transceiver to the second transceiver and a second channel may transmit light from the second transceiver to the first transceiver. In one embodiment, the first optical device 21 can be a receiver and the second optical device 22 can be an emitter.

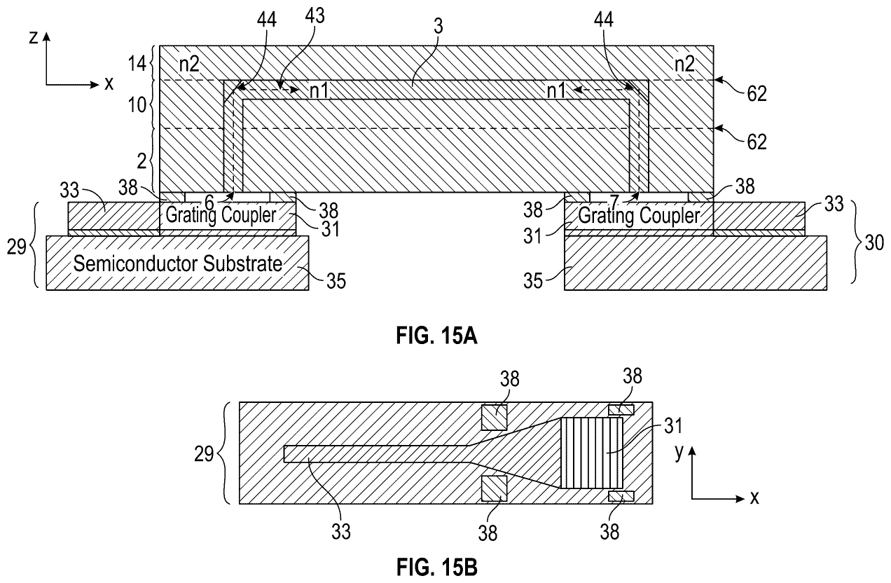

FIG. 15A illustrates an optical component 1 comprising one or more dielectric layers directly bonded together through bonding interfaces 62, according to one embodiment. The component 1 in FIG. 15A may comprise one or more features described above with respect to FIG. 14. For example, the optical component 1 in FIG. 15A comprises a first optical channel 3 extending from a first port 6 at a first side 4 of the optical component 1 to a second port 7 at the first side 4 of the optical component 1. The first optical channel 3 extends through the first and second dielectric layers 2, 10. Like the embodiment presented in FIG. 14, the embodiment presented in FIG. 15A the first optical channel 3 is configured to transmit an electromagnetic signal 43 from a first optical device 29 to a second optical device 30, or from the second optical device 30 to the first optical device 29. In one embodiment, the first optical device 29 comprises an optical waveguide 33 and a grating coupler 31 configured to couple light from the optical waveguide 33 to the first optical channel 3 through the first port 6 and couple light from the first optical channel 3 to the optical waveguide 33 to through the first port 6. Additionally, the second optical device 30 may comprise an optical waveguide 33 and a grating coupler 31 configured to couple light from the optical waveguide 33 to the first optical channel 3 through the second port 7 and couple light from the first optical channel 3 to the optical waveguide 33 through the second port 7. In some examples, the optical waveguide 33 can be a silicon-on-silica waveguide formed on a semiconductor substrate (e.g., silicon substrate 35). In some other examples, the optical waveguide 33 can be a polymer waveguide, a semiconductor waveguide comprising compound semiconductor material, or a silica waveguide. In some implementations the first and the second optical devices 29, 30 are bonded to the optical component 1 through a plurality of bonding pads 38. In some cases, the plurality of the optical pads may enable bonding the optical component 1 and the first and the second optical devices and/or provide a gap between a top surface of the grating coupler and the bottom surface of optical component 1 for improved optical coupling. An optical pad of the plurality of optical pads may comprise a lithographically defined dielectric pad formed on a substrate (e.g., substrate 35). A top surface of the optical pad may be configured to bond to the bottom surface 4 of the optical component 1. In some cases, the optical pad may provide a spacing between the bottom surface 4 and a top surface of a grating coupler (e.g., grating coupler 31) to improve optical coupling between an optical waveguide (e.g., optical waveguides 33) and a port (e.g., port 6 or 7) of the optical component 1. In some such cases, a thickness of the optical pad along a direction perpendicular to a major surface of the substrate 35 (e.g., along y-axis) can be larger than a thickness of the grating coupler. FIG. 15B shows a top view of the first optical device 29 comprising the optical waveguide 33, the grating coupler 31, and a plurality of bonding pads 38. While four optical pads are shown, in various embodiments, the number of pads can be larger or smaller.

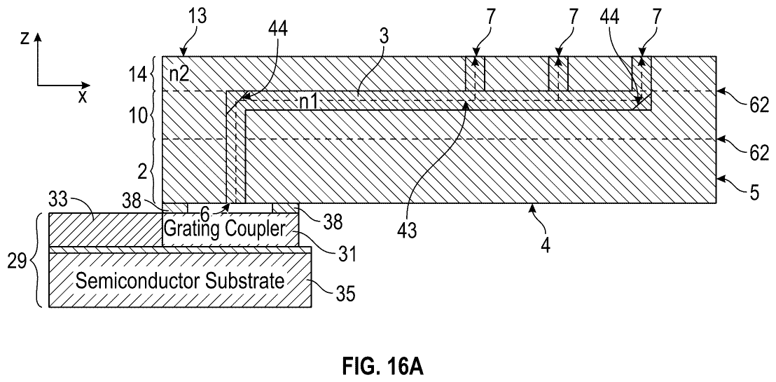

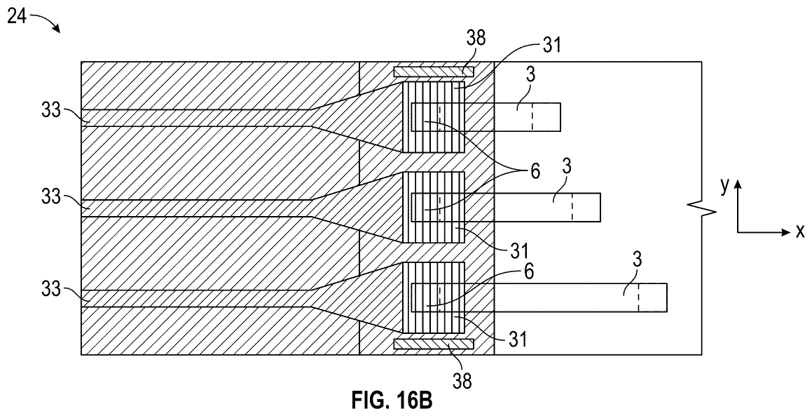

FIG. 16A illustrates an optical component 1, according to one embodiment. In FIG. 16A, the optical component 1 comprises a first plurality of optical channels 3 extending from a first plurality of ports 6 at the first side 4 of the optical component 1 to a second plurality of ports 7 at the top side 13 of the optical component 1. The first plurality of optical channels 3 are coupled to a second plurality of optical channels 33 in a second optical device 29 through a first plurality of grating couplers 31. The second optical device 29 is direct bonded to the optical component 1 through a plurality of bonding pads 38 as shown in FIGS. 16A and 16B. In one embodiment, the first and second plurality of optical channels 3, 33 are optical waveguides. In one embodiment, the optical waveguides are silica waveguides formed in a semiconductor substrate 35.

FIG. 16B shows a top view of the second optical device 29 comprising the plurality of bonding pads 38, and the second plurality of optical channels 3, which taper into the plurality of grating couplers 31. FIG. 16B also shows a bottom view of the optical component 1 and the alignment between optical component 1 and the second optical device 29. The bottom view shows optical component 1 comprising the first plurality of optical channels 3, terminating at the first plurality of ports 6.

In the illustrated embodiment of FIG. 16A, multiple optical waveguides can propagate light transmitted through multiple inputs at a narrow pitch from one optical device 29 to multiple outputs arranged as an array of outputs at a larger pitch. Such a configuration can allow the usage of multiple light sources (e.g., lasers, laser diodes, LEDs, etc.) while maintaining the light sources on a separate device. The illustrated embodiment may be beneficial in the situations where another device (not shown) that is to receive the transmitted light from device 29 is sensitive to heat or otherwise would benefit from being separated from the multitude of power-providing components to the light sources. In other embodiments, light of different wavelengths can be provided through device 29 and propagated through the optical channels 3 in optical component 1 and transmitted through the output ports at different locations on the top side 13 of the optical component 1. Another device can be connected to the outputs and receive the light of varying wavelength. In other embodiments, the light of varying wavelength could be received by multiple external devices.

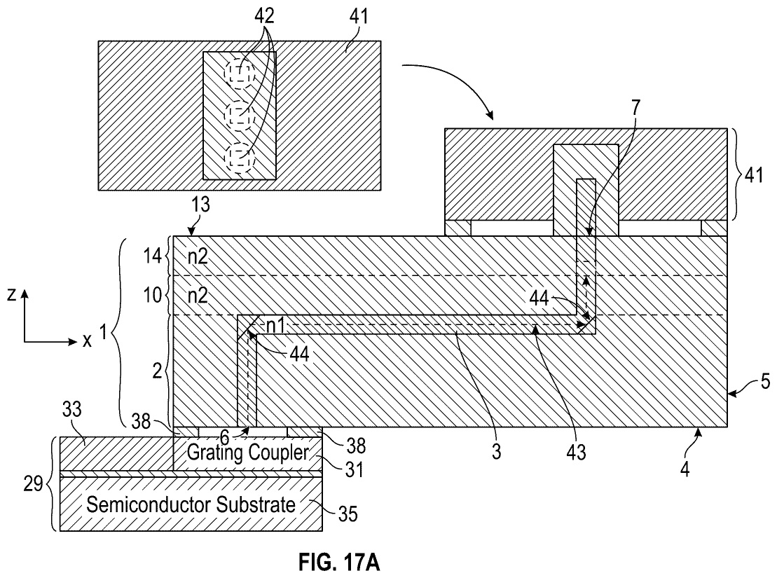

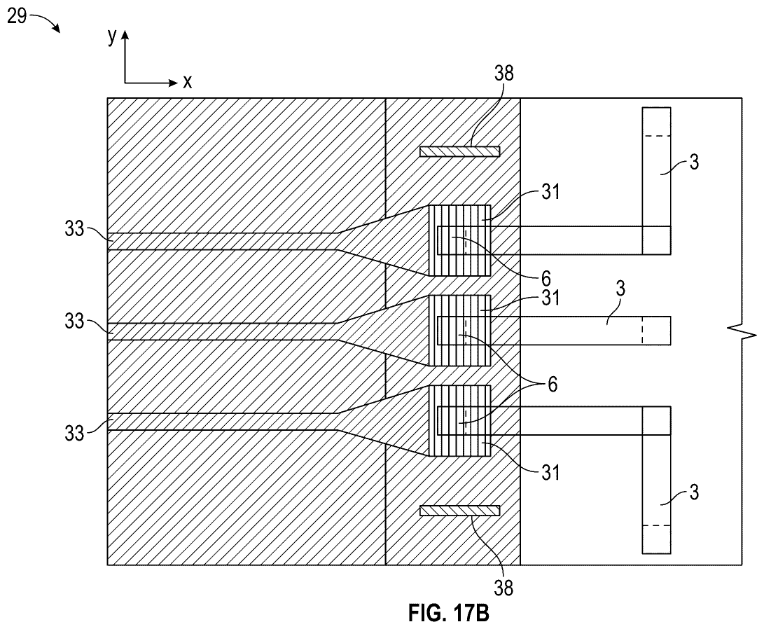

FIG. 17A illustrates a side view of an optical assembly comprising an optical component 1, according to one embodiment. The optical component 1 may be configured to couple light from one or more optical waveguides of a first optical device 29 to one or more optical ports of a second optical device 41 positioned above the optical component 1, and vice versa. The optical component 1 may comprise one or more dielectric layers directly bonded together through bonding interfaces 62. In some examples, the optical component 1 may comprise three dielectric layers where an individual dielectric layer comprises at least a vertical (e.g., extending along z-axis) or a horizontal (e.g., extending along x-axis) optical waveguide region. When these three layers are bonded together, the optical waveguide regions form at least one optical channel (or waveguide) optically connecting at least one input port to one output port of the optical component 1. The optical component 1 may comprise a first plurality of optical channels 3 extending from a first plurality of ports 6 at the first side 4 of the optical component 1 to a second plurality of ports 7 at the top side 13 of the optical component 1. The plurality of optical channels 3 are coupled to a plurality of optical waveguides 33 in the first optical device 29 through a first plurality of grating couplers 31. The first optical device 29 is directly bonded to the optical component 1 through a plurality of bonding pads 38 as shown in FIGS. 17A and 17B (and described above with respect to FIGS. 15A-B). The optical assembly shown in FIG. 17A comprises a first optical device 29 optically coupled to a second optical device 41 via the optical component 1. In some examples, the second optical device comprises a multi-fiber connector 41 (e.g., an MT type connector) that includes a plurality of fibers 42, wherein a core region of each fiber is configured to receive light from the optical component 1. In some cases, multi-fiber connector 41 may be directly bonded to a top surface 13 of the optical component 1 (e.g., via one or more bonding pads 38). In some other examples, the optical component 1 may further comprise an optical connector receiver (e.g., a socket) configured to mechanically couple the multi-fiber connector 41 to the optical component 1 and align the core regions of the plurality of fibers 42 to the second plurality of ports 7 of the plurality of optical channels 3. In some embodiments, the first optical device 29 and the optical component 1 in FIG. 17A may comprise one or more features described above with respect to first optical device 29 and the optical component 1 in FIGS. 15A-B.

The inset shows a cross-sectional bottom view of the optical component 1 and the alignment between the ports 7 of the plurality optical channels 3 (in the optical component 1) and the plurality of the fibers 42 of the multi-fiber connector 41. The lateral spacing between the plurality of channels 3 at the first side 4 of the optical component 1 is less than the lateral spacing between the plurality of optical channels 3 at the top side 13 of the optical component 1.

FIG. 17B shows a top view of the first optical device 29 bonded to the optical component 1 via a plurality of bonding pads 38. The plurality of optical waveguide 33, are optically coupled to the plurality of optical channels 3 in the optical component 1 via the plurality of grating couplers 31. In one embodiment, a first lateral spacing (e.g., along x or y axis) between the first plurality of ports 6 at the bottom surface 4 of the optical component 1 is smaller than a second lateral spacing between the second plurality of ports 6 at the top side 13 of the optical component 1. As such, the optical component I can optically couple a plurality of output ports (e.g., grating couplers 31) of the first the optical device 29 having a first pitch to a plurality of a second optical device (e.g., multi-fiber connector 41) having a second pitch such that individual input and output ports are aligned with the corresponding ports of the individual optical channels in the optical component 1. In some examples, the first pitch can be from 50 nm to 100 nm, 100 nm to 0.5 microns, 0.5 microns to 1 micron, from 5microns to 10 microns, from 10 microns to 20 microns, from 20 microns to 30 microns, or any ranges formed by these values or larger or smaller values. In some examples, the second pitch can be from 50 microns to 70 microns, from 70 microns to 90 microns, from 90 microns to 110microns, or any ranges formed by these values or larger or smaller values. In one embodiment, the lateral distances separating the first plurality of optical channels 3 at the top side 13 of the optical component 1 is configured to accommodate alignment with the core regions of the plurality of fiber 42. In one embodiment, the diameter of a fiber can be from 50 microns to 500 microns, and the diameter of the core region can be from 5 microns to 400 microns.

Similar to the illustrated embodiment of FIG. 16A, the embodiment in FIG. 17A shows that multiple optical waveguides can propagate light transmitted through multiple inputs at a narrow pitch from one optical device 29 to multiple outputs arranged as an array of outputs at a larger pitch within a connector, such as an MT-type connector. Such a configuration can allow the usage of multiple light sources (e.g., lasers) while maintaining the light sources on a separate device. The illustrated embodiment may be beneficial in the situations where another device (not shown) that is to receive the transmitted light from device 29 is sensitive to heat or otherwise would benefit from being separated from the multitude of power-providing components to the light sources. In other embodiments, light of different wavelengths can be provided through device 29 and propagated through the optical channels 3 in optical component 1 and transmitted through the output ports at different locations on the top side 13 of the optical component 1. Another device can be coupled to the optical component 1 via a connector (e.g., 41) and receive the light of varying wavelengths.

Various embodiments disclosed herein relate to directly bonded structures in which two or more elements can be directly bonded to one another without an intervening adhesive. Such processes and structures are referred to herein as “direct bonding” processes or “directly bonded” structures. Direct bonding can involve bonding of one material on one element and one material on the other element (also referred to as “uniform” direct bond herein), where the materials on the different elements need not be the same, without traditional adhesive materials. Direct bonding can also involve bonding of multiple materials on one element to multiple materials on the other element (e.g., hybrid bonding).

In some implementations (not illustrated), each bonding layer has one material. In these uniform direct bonding processes, only one material on each element is directly bonded. Example uniform direct bonding processes include the ZIBOND® techniques commercially available from Adeia of San Jose, CA. The materials of opposing bonding layers on the different elements can be the same or different, and may comprise elemental or compound materials. For example, in some embodiments, nonconductive bonding layers can be blanket deposited over the base substrate portions without being patterned with conductive features (e.g., without pads). In other embodiments, the bonding layers can be patterned on one or both elements, and can be the same or different from one another, but one material from each element is directly bonded without adhesive across surfaces of the elements (or across the surface of the smaller element if the elements are differently-sized). In another implementation of uniform direct bonding, one or both of the nonconductive bonding layers may include one or more conductive features, but the conductive features are not involved in the bonding. For example, in some implementations, opposing nonconductive bonding layers can be uniformly directly bonded to one another, and through substrate vias (TSVs) can be subsequently formed through one element after bonding to provide electrical communication to the other element.

In various embodiments, the bonding layers 108a and/or 108b can comprise a non-conductive material such as a dielectric material or an undoped semiconductor material, such as undoped silicon, which may include native oxide. Suitable dielectric bonding surface or materials for direct bonding include but are not limited to inorganic dielectrics, such as silicon oxide, silicon nitride, or silicon oxynitride, or can include carbon, such as silicon carbide, silicon oxycarbonitride, low K dielectric materials, SiCOH dielectrics, silicon carbonitride or diamond-like carbon or a material comprising a diamond surface. Such carbon-containing ceramic materials can be considered inorganic, despite the inclusion of carbon. In some embodiments, the dielectric materials at the bonding surface do not comprise polymer materials, such as epoxy (e.g., epoxy adhesives, cured epoxies, or epoxy composites such as FR-4 materials), resin or molding materials.

In other embodiments, the bonding layers can comprise an electrically conductive material, such as a deposited conductive oxide material, e.g., indium tin oxide (ITO), as disclosed in U.S. Provisional Patent Application No. 63/524,564, filed Jun. 30, 2023, the entire contents of which is incorporated by reference herein in its entirety for providing examples of conductive bonding layers without shorting contacts through the interface.

In direct bonding, first and second elements can be directly bonded to one another without an adhesive, which is different from a deposition process and results in a structurally different interface compared to that produced by deposition. In one application, a width of the first element in the bonded structure is similar to a width of the second element. In some other embodiments, a width of the first element in the bonded structure is different from a width of the second element. The width or area of the larger element in the bonded structure may be at least 10% larger than the width or area of the smaller element. Further, the interface between directly bonded structures, unlike the interface beneath deposited layers, can include a defect region in which nanometer-scale voids (nanovoids) are present. The nanovoids may be formed due to activation of one or both of the bonding surfaces (e.g., exposure to a plasma, explained below).

The bond interface between non-conductive bonding surfaces can include a higher concentration of materials from the activation and/or last chemical treatment processes compared to the bulk of the bonding layers. For example, in embodiments that utilize a nitrogen plasma for activation, a nitrogen concentration peak can be formed at the bond interface. In some embodiments, the nitrogen concentration peak may be detectable using secondary ion mass spectroscopy (SIMS) techniques. In various embodiments, for example, a nitrogen termination treatment (e.g., exposing the bonding surface to a nitrogen-containing plasma) can replace OH groups of a hydrolyzed (OH-terminated) surface with NH₂ molecules, yielding a nitrogen-terminated surface. In embodiments that utilize an oxygen plasma for activation, an oxygen concentration peak can be formed at the bond interface between non-conductive bonding surfaces. In some embodiments, the bond interface can comprise silicon oxynitride, silicon oxycarbonitride, or silicon carbonitride. The direct bond can comprise a covalent bond, which is stronger than van Der Waals bonds. The bonding layers can also comprise polished surfaces that are planarized to a high degree of smoothness.

In direct bonding processes, such as uniform direct bonding and hybrid bonding, two elements are bonded together without an intervening adhesive. In non-direct bonding processes that utilize an adhesive, an intervening material is typically applied to one or both elements to effectuate a physical connection between the elements. For example, in some adhesive-based processes, a flowable adhesive (e.g., an organic adhesive, such as an epoxy), which can include conductive filler materials, can be applied to one or both elements and cured to form the physical (rather than chemical or covalent) connection between elements. Typical organic adhesives lack strong chemical or covalent bonds with either element. In such processes, the connections between the elements are weak and/or readily reversed, such as by reheating or defluxing.

By contrast, direct bonding processes join two elements by forming strong chemical bonds (e.g., covalent bonds) between opposing nonconductive materials. For example, in direct bonding processes between nonconductive materials, one or both nonconductive surfaces of the two elements are planarized and chemically prepared (e.g., activated and/or terminated) such that when the elements are brought into contact, strong chemical bonds (e.g., covalent bonds) are formed, which are stronger than Van der Waals or hydrogen bonds. In some implementations (e.g., between opposing dielectric surfaces, such as opposing silicon oxide surfaces), the chemical bonds can occur spontaneously at room temperature upon being brought into contact. In some implementations, the chemical bonds between opposing non-conductive materials can be strengthened after annealing the elements.

As noted above, hybrid bonding is a species of direct bonding in which both non-conductive features directly bond to non-conductive features, and conductive features directly bond to conductive features of the elements being bonded. The non-conductive bonding materials and interface can be as described above, while the conductive bond can be formed, for example, as a direct metal-to-metal connection. In conventional metal bonding processes, a fusible metal alloy (e.g., solder) can be provided between the conductors of two elements, heated to melt the alloy, and cooled to form the connection between the two elements. The resulting bond often evinces sharp interfaces with conductors from both elements, and is subject to reversal by reheating. By way of contrast, direct metal bonding as employed in hybrid bonding does not require melting or an intermediate fusible metal alloy, and can result in strong mechanical and electrical connections, often demonstrating interdiffusion of the bonded conductive features with grain growth across the bonding interface between the elements, even without the much higher temperatures and pressures of thermocompression bonding.

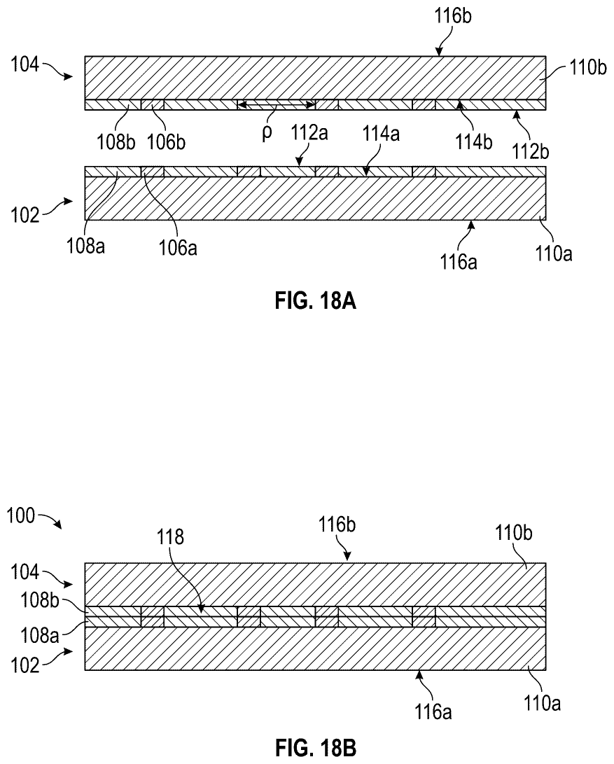

FIGS. 18A and 18B schematically illustrate cross-sectional side views of first and second elements 102, 104 prior to and after, respectively, a process for forming a directly bonded structure, and more particularly a hybrid bonded structure, according to some embodiments. In FIG. 18B, a bonded structure 100 comprises the first and second elements 102 and 104 that are directly bonded to one another at a bond interface 118 without an intervening adhesive. Conductive features 106a of a first element 102 may be electrically connected to corresponding conductive features 106b of a second clement 104. In the illustrated hybrid bonded structure 100, the conductive features 106a are directly bonded to the corresponding conductive features 106b without intervening solder or conductive adhesive.

The conductive features 106a and 106b of the illustrated embodiment are embedded in, and can be considered part of, a first bonding layer 108a of the first element 102 and a second bonding layer 108b of the second element 104, respectively. Field regions of the bonding layers 108a, 108b extend between and partially or fully surround the conductive features 106a, 106b. The bonding layers 108a, 108b can comprise layers of non-conductive materials suitable for direct bonding, as described above, and the field regions are directly bonded to one another without an adhesive. The non-conductive bonding layers 108a, 108b can be disposed on respective front sides 114a, 114b of base substrate portions 110a, 110b.

The first and second elements 102, 104 can comprise microelectronic elements, such as semiconductor elements, including, for example, integrated device dies, wafers, passive devices, discrete active devices such as power switches, MEMS, etc. In some embodiments, the base substrate portion can comprise a device portion, such as a bulk semiconductor (e.g., silicon) portion of the elements 102, 104, and back-end-of-line (BEOL) interconnect layers over such semiconductor portions. The bonding layers 108a, 108b can be provided as part of such BEOL layers during device fabrication, as part of redistribution layers (RDL), or as specific bonding layers added to existing devices, with bond pads extending from underlying contacts. Active devices and/or circuitry can be patterned and/or otherwise disposed in or on the base substrate portions 110a, 110b, and can electrically communicate with at least some of the conductive features 106a, 106b. Active devices and/or circuitry can be disposed at or near the front sides 114a, 114b of the base substrate portions 110a, 110b, and/or at or near opposite backsides 116a, 116b of the base substrate portions 110a, 110b. In other embodiments, the base substrate portions 110a, 110b may not include active circuitry, but may instead comprise dummy substrates, passive interposers, passive optical elements (e.g., glass substrates, gratings, lenses), etc. The bonding layers 108a, 108b are shown as being provided on the front sides of the elements, but similar bonding layers can be additionally or alternatively provided on the back sides of the elements.

In some embodiments, the base substrate portions 110a, 110b can have significantly different coefficients of thermal expansion (CTEs), and bonding elements that include such different based substrate portions can form a heterogenous bonded structure. The CTE difference between the base substrate portions 110a and 110b, and particularly between bulk semiconductor (typically single crystal) portions of the base substrate portions 110a, 110b, can be greater than 5 ppm/° C. or greater than 10 ppm/° C. For example, the CTE difference between the base substrate portions 110a and 110b can be in a range of 5 ppm/°° C. to 100 ppm/° C., 5 ppm/°° C. to 40 ppm/° C., 10 ppm/°° C. to 100 ppm/° C., or 10 ppm/°° C. to 40 ppm/° C.

In some embodiments, one of the base substrate portions 110a, 110b can comprise optoelectronic single crystal materials, including perovskite materials, that are useful for optical piezoelectric or pyroelectric applications, and the other of the base substrate portions 110a, 110b comprises a more conventional substrate material. For example, one of the base substrate portions 110a, 110b comprises lithium tantalate (LiTaO3) or lithium niobate (LiNbO3), and the other one of the base substrate portions 110a, 110b comprises silicon (Si), quartz, fused silica glass, sapphire, or a glass. In other embodiments, one of the base substrate portions 110a, 110b comprises a III-V single semiconductor material, such as gallium arsenide (GaAs) or gallium nitride (GaN), and the other one of the base substrate portions 110a, 110b can comprise a non-III-V semiconductor material, such as silicon (Si), or can comprise other materials with similar CTE, such as quartz, fused silica glass, sapphire, or a glass. In still other embodiments, one of the base substrate portions 110a, 110b comprises a semiconductor material and the other of the base substrate portions 110a, 110b comprises a packaging material, such as a glass, organic or ceramic substrate.

In some arrangements, the first element 102 can comprise a singulated element, such as a singulated integrated device die. In other arrangements, the first element 102 can comprise a carrier or substrate (e.g., a semiconductor wafer) that includes a plurality (e.g., tens, hundreds, or more) of device regions that, when singulated, forms a plurality of integrated device dies, though in other embodiments such a carrier can be a package substrate or a passive or active interposer. Similarly, the second element 104 can comprise a singulated element, such as a singulated integrated device die. In other arrangements, the second element 104 can comprise a carrier or substrate (e.g., a semiconductor wafer). The embodiments disclosed herein can accordingly apply to wafer-to-wafer (W2W), die-to-die (D2D), or die-to-wafer (D2W) bonding processes. In W2W processes, two or more wafers can be directly bonded to one another (e.g., direct hybrid bonded) and singulated using a suitable singulation process. After singulation, side edges of the singulated structure (e.g., the side edges of the two bonded elements) can be substantially flush (substantially aligned x-y dimensions) and/or the edges of the bonding interfaces for both bonded and singulated elements can be coextensive, and may include markings indicative of the common singulation process for the bonded structure (e.g., saw markings if a saw singulation process is used).

While only two elements 102, 104 are shown, any suitable number of elements can be stacked in the bonded structure 100. For example, a third element (not shown) can be stacked on the second element 104, a fourth element (not shown) can be stacked on the third element, and so forth. In such implementations, through substrate vias (TSVs) can be formed to provide vertical electrical communication between and/or among the vertically-stacked elements. Additionally or alternatively, one or more additional elements (not shown) can be stacked laterally adjacent one another along the first element 102. In some embodiments, a laterally stacked additional element may be smaller than the second element. In some embodiments, the bonded structure can be encapsulated with an insulating material, such as an inorganic dielectric (e.g., silicon oxide, silicon nitride, silicon oxynitrocarbide, etc.). One or more insulating layers can be provided over the bonded structure. For example, in some implementations, a first insulating layer can be conformally deposited over the bonded structure, and a second insulating layer (which may include be the same material as the first insulating layer, or a different material) can be provided over the first insulating layer.

To effectuate direct bonding between the bonding layers 108a, 108b, the bonding layers 108a, 108b can be prepared for direct bonding. Non-conductive bonding surfaces 112a, 112b at the upper or exterior surfaces of the bonding layers 108a, 108b can be prepared for direct bonding by polishing, for example, by chemical mechanical polishing (CMP). The roughness of the polished bonding surfaces 112a, 112b can be less than 30 Å rms. For example, the roughness of the bonding surfaces 112a and 112b can be in a range of about 0.1 Å rms to 15 Å rms, 0.5 Å rms to 10 Å rms, or 1 Å rms to 5 Årms. Polishing can also be tuned to leave the conductive features 106a, 106b recessed relative to the field regions of the bonding layers 108a, 108b.

Preparation for direct bonding can also include cleaning and exposing one or both of the bonding surfaces 112a, 112b to a plasma and/or etchants to activate at least one of the surfaces 112a, 112b. In some embodiments, one or both of the surfaces 112a, 112b can be terminated with a species after activation or during activation (e.g., during the plasma and/or etch processes). Without being limited by theory, in some embodiments, the activation process can be performed to break chemical bonds at the bonding surface(s) 112a, 112b, and the termination process can provide additional chemical species at the bonding surface(s) 112a, 112b that alters the chemical bond and/or improves the bonding energy during direct bonding. In some embodiments, the activation and termination are provided in the same step, e.g., a plasma to activate and terminate the surface(s) 112a, 112b. In other embodiments, one or both of the bonding surfaces 112a, 112b can be terminated in a separate treatment to provide the additional species for direct bonding. In various embodiments, the terminating species can comprise nitrogen. For example, in some embodiments, the bonding surface(s) 112a, 112b can be exposed to a nitrogen-containing plasma. Other terminating species can be suitable for improving bonding energy, depending upon the materials of the bonding surfaces 112a, 112b. Further, in some embodiments, the bonding surface(s) 112a, 112b can be exposed to fluorine. For example, there may be one or multiple fluorine concentration peaks at or near a bond interface 118 between the first and second elements 102, 104. Typically, fluorine concentration peaks occur at interfaces between material layers. Additional examples of activation and/or termination treatments may be found in U.S. Pat. Nos. 9,391,143 at Col. 5, line 55 to Col. 7, line 3; Col. 8, line 52 to Col. 9, line 45; Col. 10, lines 24-36; Col. 11, lines 24-32, 42-47, 52-55, and 60-64; Col. 12, lines 3-14, 31-33, and 55-67; Col. 14, lines 38-40 and 44-50; and 10,434,749 at Col. 4, lines 41-50; Col. 5, lines 7-22, 39, 55-61; Col. 8, lines 25-31, 35-40, and 49-56; and Col. 12, lines 46-61, the activation and termination teachings of which are incorporated by reference herein.

Thus, in the directly bonded structure 100, the bond interface 118 between two non-conductive materials (e.g., the bonding layers 108a, 108b) can comprise a very smooth interface with higher nitrogen (or other terminating species) content and/or fluorine concentration peaks at the bond interface 118. In some embodiments, the nitrogen and/or fluorine concentration peaks may be detected using various types of inspection techniques, such as SIMS techniques. The polished bonding surfaces 112a and 112b can be slightly rougher (e.g., about 1 Å rms to 30 Å rms, 3 Å rms to 20 Å rms, or possibly rougher) after an activation process. In some embodiments, activation and/or termination can result in slightly smoother surfaces prior to bonding, such as where a plasma treatment preferentially erodes high points on the bonding surface.

The non-conductive bonding layers 108a and 108b can be directly bonded to one another without an adhesive. In some embodiments, the elements 102, 104 are brought together at room temperature, without the need for application of a voltage, and without the need for application of external pressure or force beyond that used to initiate contact between the two elements 102, 104. Contact alone can cause direct bonding between the non-conductive surfaces of the bonding layers 108a, 108b (e.g., covalent dielectric bonding). Subsequent annealing of the bonded structure 100 can cause the conductive features 106a, 106b to directly bond.

In some embodiments, prior to direct bonding, the conductive features 106a, 106b are recessed relative to the surrounding field regions, such that a total gap between opposing contacts after dielectric bonding and prior to anneal is less than 15 nm, or less than 10 nm. Because the recess depths for the conductive features 106a and 106b can vary across each element, due to process variation, the noted gap can represent a maximum or an average gap between corresponding conductive features 106a, 106b of two joined elements (prior to anneal). Upon annealing, the conductive features 106a and 106b can expand and contact one another to form a metal-to-metal direct bond.

During annealing, the conductive features 106a, 106b (e.g., metallic material) can expand while the direct bonds between surrounding non-conductive materials of the bonding layers 108a, 108b resist separation of the elements, such that the thermal expansion increases the internal contact pressure between the opposing conductive features. Annealing can also cause metallic grain growth across the bonding interface, such that grains from one element migrate across the bonding interface at least partially into the other element, and vice versa. Thus, in some hybrid bonding embodiments, opposing conductive materials are joined without heating above the conductive materials' melting temperature, such that bonds can form with lower anneal temperatures compared to soldering or thermocompression bonding.

In various embodiments, the conductive features 106a, 106b can comprise discrete pads, contacts, electrodes, or traces at least partially embedded in the non-conductive field regions of the bonding layers 108a, 108b. In some embodiments, the conductive features 106a, 106b can comprise exposed contact surfaces of TSVs (e.g., through silicon vias).

As noted above, in some embodiments, in the elements 102, 104 of FIG. 18A prior to direct bonding, portions of the respective conductive features 106a and 106b can be recessed below the non-conductive bonding surfaces 112a and 112b, for example, recessed by less than 30 nm, less than 20 nm, less than 15 nm, or less than 10 nm, for example, recessed in a range of 2 nm to 20 nm, or in a range of 4 nm to 10 nm. Due to process variation, both dielectric thickness and conductor recess depths can vary across an element. Accordingly, the above recess depth ranges may apply to individual conductive features 106a, 106b or to average depths of the recesses relative to local non-conductive field regions. Even for an individual conductive feature 106a, 106b, the vertical recess can vary across the feature, and so can be measured at or near the lateral middle or center of the cavity in which a given conductive feature 106a, 106b is formed, or can be measured at the sides of the cavity.

Beneficially, the use of hybrid bonding techniques (such as Direct Bond Interconnect, or DBI®, techniques commercially available from Adeia of San Jose, CA) can enable high density of connections between conductive features 106a, 106b across the direct bond interface 118 (e.g., small or fine pitches for regular arrays).

In some embodiments, a pitch p of the conductive features 106a, 106b, such as conductive traces embedded in the bonding surface of one of the bonded elements, may be less than 40 μm, less than 20 μm, less than 10 μm, less than 5 μm, less than 2 μm, or even less than 1 μm. For some applications, the ratio of the pitch of the conductive features 106a and 106b to one of the lateral dimensions (e.g., a diameter) of the bonding pad is less than is less than 20, or less than 10, or less than 5, or less than 3 and sometimes desirably less than 2. In various embodiments, the conductive features 106a and 106b and/or traces can comprise copper or copper alloys, although other metals may be suitable, such as nickel, aluminum, or alloys thereof. The conductive features disclosed herein, such as the conductive features 106a and 106b, can comprise fine-grain metal (e.g., a fine-grain copper). Further, a major lateral dimension (e.g., a pad diameter) can be small as well, e.g., in a range of about 0.25 μm to 30 μm, in a range of about 0.25 μm to 5 μm, or in a range of about 0.5 μm to 5 μm.

For hybrid bonded elements 102, 104, as shown, the orientations of one or more conductive features 106a, 106b from opposite elements can be opposite to one another. As is known in the art, conductive features in general can be formed with close to vertical sidewalls, particularly where directional reactive ion etching (RIE) defines the conductor sidewalls either directly though etching the conductive material or indirectly through etching surrounding insulators in damascene processes. However, some slight taper to the conductor sidewalls can be present, wherein the conductor becomes narrower farther away from the surface initially exposed to the etch. The taper can be even more pronounced when the conductive sidewall is defined directly or indirectly with isotropic wet or dry etching. In the illustrated embodiment, at least one conductive feature 106b in the bonding layer 108b (and/or at least one internal conductive feature, such as a BEOL feature) of the upper clement 104 may be tapered or narrowed upwardly, away from the bonding surface 112b. By way of contrast, at least one conductive feature 106a in the bonding layer 108a (and/or at least one internal conductive feature, such as a BEOL feature) of the lower element 102 may be tapered or narrowed downwardly, away from the bonding surface 112a. Similarly, any bonding layers (not shown) on the backsides 116a, 116b of the elements 102, 104 may taper or narrow away from the backsides, with an opposite taper orientation relative to front side conductive features 106a, 106b of the same element.

As described above, in an anneal phase of hybrid bonding, the conductive features 106a, 106b can expand and contact one another to form a metal-to-metal direct bond. In some embodiments, the materials of the conductive features 106a, 106b of opposite elements 102, 104 can interdiffuse during the annealing process. In some embodiments, metal grains grow into each other across the bond interface 118. In some embodiments, the metal is or includes copper, which can have grains oriented along the 111 crystal plane for improved copper diffusion across the bond interface 118. In some embodiments, the conductive features 106a and 106b may include nanotwinned copper grain structure, which can aid in merging the conductive features during anneal. There is substantially no gap between the non-conductive bonding layers 108a and 108b at or near the bonded conductive features 106a and 106b. In some embodiments, a barrier layer may be provided under and/or laterally surrounding the conductive features 106a and 106b (e.g., which may include copper). In other embodiments, however, there may be no barrier layer under the conductive features 106a and 106b.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements. Likewise, the word “connected,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

While certain embodiments have been described, these embodiments have been presented by way of example only and are not intended to limit the scope of the disclosure. For example, while illustrated embodiments include preparation for hybrid bonding, the skilled artisan will appreciate that the techniques taught herein can be useful for direct metal bonding even in the absence of direct dielectric bonding. Indeed, the novel apparatus, methods, and systems described herein may be embodied in a variety of other forms; furthermore, various omissions, substitutions, and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. It is also contemplated that various combinations or sub-combinations of the specific features and aspects of the embodiments may be made and still fall within the scope. The accompanying claims and their equivalents are intended to cover such forms or modifications as would fall within the scope and spirit of the disclosure.

1. An optical component comprising:
a first optical element;
a second optical element disposed over the first optical element;
a first optical channel through at least a portion of the first optical element, the first optical channel extending between a first port at a first side of the optical component and a second port at a second side of the optical component; and
a second optical channel through at least a portion of the second optical element, the second optical channel extending between a third port at the first side of the optical component and a fourth port,
wherein the first and third ports are spaced apart by a first distance along the first side, and the second and fourth ports are spaced apart by a second distance along an exterior surface of the optical component, the first distance different from the second distance.

2. The optical component of claim 1, wherein the second optical element is directly bonded to the first optical element without an intervening adhesive.

3. The optical component of claim 1, wherein the fourth port is disposed at the second side of the optical component, wherein the second side is parallel to or at an angle to the first of the optical component.

4. (canceled)

5. (canceled)

6. The optical component of claim 1, wherein the first optical channel is a waveguide.

7. The optical component of claim 1, wherein the first distance is less than the second distance.

8. (canceled)

9. (canceled)

10. (canceled)

11. The optical component of claim 1, further comprising:
a third optical channel through at least a portion of the first optical element, the third optical channel extending between a fifth port at the first side of the optical component and a sixth port at the second side of the optical component; and
a fourth optical channel through at least a portion of the second optical element, the fourth optical channel extending between a seventh port at the first side of the optical component and an eighth port at the second side of the optical component,
wherein the fifth and seventh ports are spaced apart by a third distance, and the sixth and eighth ports are spaced apart by a fourth distance, the third distance different from the fourth distance.

12. The optical component of claim 11, further comprising an emitter directly bonded to the first and second optical channels and a receiver directly bonded to the third and fourth optical channels.

13. (canceled)

14. (canceled)

15. (canceled)

16. (canceled)

17. (canceled)

18. (canceled)

19. (canceled)

20. (canceled)

21. (canceled)

22. (canceled)

23. The optical component of claim 11, further comprising an adapter assembly that couples an optical fiber to at least the second port.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (Canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. An optical component comprising:
a first optical element comprising a bottom side and a top side;
at least one optical channel through at least a portion of the first optical element;
a second optical element directly bonded to the top side of the first optical element without an intervening adhesive, the second optical element at least partially defining the at least one optical channel;
a first input port at the bottom side of the first optical element; and
a first output port at the bottom side of the first optical element, wherein the at least one optical channel extends between the first input port and the first output port.

78. The optical component of claim 77, wherein the at least one optical channel is an optical waveguide.

79. The optical component of claim 77, wherein the optical component bridges a first die and a second die.

80. The optical component of claim 77, further comprising a first optical device coupled to the first input port and a second optical device coupled to the first output port.

81. The optical component of claim 80, wherein the first optical device is an emitter or a receiver.

82. The optical component of claim 80, wherein the first optical device comprises an optical waveguide and a grating coupler, wherein electromagnetic radiation is propagated through the optical waveguide and the grating coupler, and the grating coupler couples the electromagnetic radiation to the first input port.

83. An optical component comprising:
a first optical element;
a second optical element directly bonded to the first optical element without an intervening adhesive;
a first optical channel through at least a portion of the first optical element, the first optical channel extending between a first port at a first side of the optical component and a second port at a second side of the optical component, and
a second optical channel through at least a portion of the second optical element, the second optical channel extending between a third port at the first side of the optical component and a fourth port at a third side of the optical component.

84. (canceled)

85. The optical component of claim 83, further comprising at least a first optical grating disposed in the first optical channel.

86. The optical component of claim 83, wherein the first optical channel comprises at least one optical power divider, the at least one optical power divider further comprising a Y-junction and a first and a second branching optical channel.

87. The optical component of claim 83, wherein the first optical channel comprises a first portion of the first optical channel and the second optical channel comprises a first portion of the second optical channel, and wherein the first portion of the first optical channel and the first portion of the second optical channel are optically coupled to form a directional coupler.

88. The optical component of claim 83, further comprising a first optical device coupled to the first and third ports and a second optical device coupled to at least the second port or the fourth port.

89. (canceled)

90. The optical component of claim 88, wherein the first optical device comprises an optical waveguide and a grating coupler, wherein electromagnetic radiation is propagated through the optical waveguide and the grating coupler, and wherein the grating coupler couples the electromagnetic radiation to the first port.
